(19) United States
(12) Patent Application Publication
(10) Pub. No.: US 2023/0373796 A1
(43) Pub. Date: Nov. 23, 2023

(54) SILICON-CARBON COMPOSITE MATERIALS WITH ENHANCED ELECTROCHEMICAL PROPERTIES

(71) Applicant: GROUP14 TECHNOLOGIES, INC., Woodinville, WA (US)

(72) Inventors: Henry R. COSTANTINO, Woodinville, WA (US); Avery J. SAKSHAUG, Snohomish, WA (US); Abirami DHANABALAN, Bothell, WA (US); Nathan D. PHILLIP, Arlington, WA (US); Christopher TIMMONS, Monroe, WA (US); Rajankumar PATEL, Pasco, WA (US)

(21) Appl. No.: 18/246,472

(22) PCT Filed: Sep. 24, 2021
(86) PCT No.: PCT/US2021/051936

§ 371 Date: Mar. 23, 2023

Related U.S. Application Data
(60) Provisional application No. 63/083,614, filed on Sep. 25, 2020.

(51) Int. Cl. C01B 33/035; C01B 32/336; H01M 4/36; H01M 4/38; H01M 4/583; H01M 4/62

(52) U.S. Cl. CPC C01B 33/035; C01B 32/336; H01M 4/364; H01M 4/386; H01M 4/583; H01M 4/625; C01P 2006/14; C01P 2006/12; C01P 2006/40; C01P 2002/82; H01M 2004/021

(57) ABSTRACT

Silicon-carbon composite materials and related processes are disclosed that overcome the challenges for providing amorphous nano-sized silicon entrained within porous carbon. Compared to other, inferior materials and processes described in the prior art, the materials and processes disclosed herein find superior utility in various applications, including energy storage devices such as lithium ion batteries.

### BACKGROUND

### Technical Field

Embodiments of the present invention generally relate to enhancing the electrochemical properties and performance of silicon-carbon composite materials that overcome the challenges for providing amorphous nano-sized silicon entrained within porous carbon. Said silicon-carbon composites are produced via chemical vapor infiltration to impregnate amorphous, nano-sized silicon within the pores of a porous scaffold. Suitable porous scaffolds include, but are not limited to, porous carbon scaffolds, for example carbon having a pore volume comprising micropores (less than 2 nm), mesopores (2 to 50 nm), and/or macropores (greater than 50 nm). Suitable precursors for the carbon scaffold include, but are not limited to, sugars and polyols, organic acids, phenolic compounds, cross-linkers, and amine compounds. Suitable compositing materials include, but are not limited to, silicon materials. Precursors for the silicon include, but are not limited to, silicon containing gases such as silane, high-order silanes (such as di-, tri-, and/or tetrasilane), and/or chlorosilane(s) (such as mono-,di-, tri-, and tetrachlorosilane) and mixtures thereof. Chemical vapor infiltration (CVI) of silicon into the pores of porous scaffold materials is accomplished by exposing said porous scaffold to silicon-containing gas (e.g., silane) at elevated temperatures. The porous carbon scaffold can be a particulate porous carbon.

A key outcome in this regard is to achieve the desired form of silicon in the desired form, namely amorphous nano-sized silicon. Furthermore, another key outcome is to achieve the silicon impregnation within the pores of the porous carbon. Yet another key outcome is to achieve enhanced electrochemical properties for the silicon-carbon composite material. Such enhancements include increasing the graphitic nature and/or conductivity of the carbon scaffold, wherein the conductivity comprises electronic and/or ionic conductivity. Such silicon-carbon composite materials with enhanced electrochemical properties have utility as anode materials for energy storage devices, for example lithium ion batteries. Also disclosed herein are manufacturing processes for preparing the silicon-carbon composite materials with enhanced electrochemical properties.

### DESCRIPTION OF THE RELATED ART

CVI is a process wherein a gaseous substrate reacts within a porous scaffold material. This approach can be employed to produce composite materials, for instance silicon-carbon composites, wherein a silicon-containing gas decomposes at elevated temperature within a porous carbon scaffold. While this approach can be employed to manufacture a variety of composite materials, there is particular interest in silicon-carbon (Si—C) composite materials. Such Si—C composite materials have utility, for example as energy storage materials, for example as an anode material within a lithium ion battery (LIB). LIBs have potential to replace devices currently used in any number of applications such as electric vehicles, consumer electronics, and grid storage. For example, current lead acid automobile batteries are not adequate for next generation all-electric and hybrid electric vehicles due to irreversible, stable sulfate formations during discharge. Lithium ion batteries are a viable alternative to the lead-based systems currently used due to their capacity, and other considerations.

To this end, there is continued strong interest in developing new LIB anode materials, particularly silicon, which has 10-fold higher gravimetric capacity than conventional graphite. However, silicon exhibits large volume change during cycling, in turn leading to electrode deterioration and solid-electrolyte interphase (SEI) instability. The most common amelioration approach is to reduce silicon particle size, for instance D_{V,50}<150 nm, for instance D_{V,50}<100 nm, for instance D_{V,50}<50 nm, for instance D_{V,50}<20 nm, for instance D_{V,50}<10 nm, for instance D_{V,50}<5 nm, for instance D_{V,50}<2 nm, either as discrete particles or within a matrix. Thus far, techniques for creating nano-scale silicon involve high-temperature reduction of silicon oxide, extensive particle diminution, multi-step toxic etching, and/or other cost prohibitive processes. Likewise, common matrix approaches involve expensive materials such as graphene or nano-graphite, and/or require complex processing and coating.

It is known from scientific literature that non-graphitizable (hard) carbon is beneficial as a LIB anode material (Liu Y, Xue, J S, Zheng T, Dahn, J R. Carbon 1996, 34:193-200; Wu, Y P, Fang, SB, Jiang, Y Y. 1998, 75:201-206; Buiel E, Dahn J R. Electrochim Acta 1999 45:121-130). The basis for this improved performance stems from the disordered nature of the graphene layers that allows Li-ions to intercalate on either side of the graphene plane allowing for theoretically double the stoichiometric content of Li ions versus crystalline graphite. Furthermore, the disordered structure improves the rate capability of the material by allowing Li ions to intercalate isotropically as opposed to graphite where lithiation can only proceed in parallel to the stacked graphene planes. Despite these desirable electrochemical properties, amorphous carbons have not seen wide-spread deployment in commercial Li-ion batteries, owing primarily to low FCE and low bulk density (<1 g/cc). Instead, amorphous carbon has been used more commonly as a low-mass additive and coating for other active material components of the battery to improve conductivity and reduce surface side reactions.

In recent years, amorphous carbon as a LIB battery material has received considerable attention as a coating for silicon anode materials. Such a silicon-carbon core-shell structure has the potential for not only improving conductivity, but also buffering the expansion of silicon as it lithiates, thus stabilizing its cycle stability and minimizing problems associated with particle pulverization, isolation, and SEI integrity (Jung, Y, Lee K, Oh, S. Electrochim Acta 2007 52:7061-7067; Zuo P, Yin G, Ma Y. Electrochim Acta 2007 52:4878-4883; Ng S H, Wang J, Wexler D, Chew S Y, Liu H K. J Phys Chem C 2007 111:11131-11138). Problems associated with this strategy include the lack of a suitable silicon starting material that is amenable to the coating process, and the inherent lack of engineered void space within the carbon-coated silicon core-shell composite particle to accommodate expansion of the silicon during lithiation. This inevitably leads to cycle stability failure due to destruction of core-shell structure and SEI layer (Beattie S D, Larcher D, Morcrette M, Simon B, Tarascon, J-M. J Electrochem Soc 2008 155:A158-A163).

An alternative to core shell structure is a structure wherein amorophous, nano-sized silicon is homogeously distributed within the porosity of a porous carbon scaffold. The porous carbon allows for desirable properties: (i) carbon porosity provides void volume to accommodate the expansion of silicon during lithiation thus reducing the net composite particle expansion at the electrode level; (ii) the disordered graphene network provides increased electrical conductivity to the silicon thus enabling faster charge/discharge rates, (iii) nano-pore structure acts as a template for the synthesis of silicon thereby dictating its size, distribution, and morphology.

To this end, the desired inverse hierarchical structure can be achieved by employing CVI wherein a silicon-containing gas can completely permeate nanoporous carbon and decompose therein to nano-sized silicon. The CVI approach confers several advantages in terms of silicon structure. One advantage is that nanoporous carbon provides nucleation sites for growing silicon while dictating maximum particle shape and size. Confining the growth of silicon within a nano-porous structure affords reduced susceptibility to cracking or pulverization and loss of contact caused by expansion. Moreover, this structure promotes nano-sized silicon to remain as amorphous phase. This property provides the opportunity for high charge/discharge rates, particularly in combination with silicon's vicinity within the conductive carbon scaffold. This system provides a high-rate-capable, solid-state lithium diffusion pathway that directly delivers lithium ions to the nano-scale silicon interface. Another benefit of the silicon provide via CVI within the carbon scaffold is the inhibition of formation of undesirable crystalline Li₁₅Si₄ phase. Yet another benefit is that the CVI process provides for void space within the particle interior.

In order to quantitate the percentage loading of silicon comprising the silicon-carbon composite, thermogravimetric analysis (TGA) may be employed. For this purpose, the silicon-composite is heated from 25° C. to 1100° C., which, without being bound by theory, provides for burn off of all carbon, and oxidation of all silicon to SiO₂. Thus, the % silicon comprising the silicon-carbon composite is calculated as

% Si=100×[[M1100×(28/(28+(16×2)))]/M°]

wherein M1100 is the mass of the silicon-carbon composite at 1100° C. and M° is the minimum mass of the silicon-carbon composite between 50° C. and 200° C. when the silicon-carbon composite is heated under air from about 25° C. to about 1100° C., as determined by thermogravimetric analysis.

In order to gauge relative amount of silicon impregnated into the porosity of the porous carbon, thermogravimetric analysis TGA may be employed. TGA can be employed to assess the fraction of silicon residing within the porosity of porous carbon relative to the total silicon present, i.e., sum of silicon within the porosity and on the particle surface. As the silicon-carbon composite is heated under air, the sample exhibits a mass increase that initiates at about 300° C. to 500° C. that reflects initial oxidation of silicon to SiO₂, and then the sample exhibits a mass loss as the carbon is burned off, and then the sample exhibits mass increase reflecting resumed conversion of silicon into SiO₂ which increases towards an asymptotic value as the temperature approaches 1100° C. as silicon oxidizes to completion. For the purposes of this analysis, it is assumed that the minimum mass recorded for the sample as it heated from 800° C. to 1100° C. represents the point at which carbon burnoff is complete. Any further mass increase beyond that point corresponds to the oxidation of silicon to SiO₂ and that the total mass at completion of oxidation is SiO₂. Thus, the percentage of unoxidized silicon after carbon burnoff as a proportion of the total amount of silicon can be determined using the formula:

Z=1.875×[(M1100 −M)/M1100]×100

where M1100 is the mass of the sample at completion of oxidation at a temperature of 1100° C., and M is the minimum mass recorded for the sample as it is heated from 800° C. to 1100° C.

Without being bound by theory, the temperature at which silicon is oxidized under TGA conditions relates to the length scale of the oxide coating on the silicon due to the diffusion of oxygen atoms through the oxide layer. Thus, silicon residing within the carbon porosity will oxidize at a lower temperature than deposits of silicon on a particle surface due to the necessarily thinner coating existing on these surfaces. In this fashion, calculation of Z is used to quantitatively assess the fraction of silicon not impregnated within the porosity of the porous carbon scaffold.

The graphitic vs. amorphous nature of carbon can be investigated by various methods as known in the art. Such methods include, but are not limited to, high resolution transmission electron microscopy (HRTEM), X-ray diffraction (XRD), and Raman spectroscopy. The latter two methods have been shown to be suitable for quantitation, as well as correlative (Z. Zhang and Q. Wang, Crystals 2017, 7(1):5).

With regards to XRD, the graphitic nature of carbon materials can be assessed by monitoring peak intensity at various 20 corresponding to various Miller indices. Without being bound by theory, diffraction lines of graphite classified into various group, such as 00l, hk0, and hkl indices, mainly because of the strong anisotropy in structure. One such species is 002, corresponding to basal planes of graphite, which is located at 2θ˜26°; this peak is prominent in highly graphitic carbon materials. Carbon material with lesser extent of graphite nature may be characterized by very broad 00l lines (e.g., 002) and shifting (e.g. 2θ˜23°) 23°, due to the lesser extent of stacked layers, and by unsymmetrical hk lines (e.g., 10 corresponding to 2θ˜43°.

With regards to Raman spectroscopy, this method can als be employed to assess graphite nature of carbon as reported in the art (L. Bokobza J.-L. Bruneel and M. Couzi, Carbon 2015, 1:77-94). To this end, the graphitic nature of carbon materials can be assessed by monitoring the ratio in peak intensity of the D band (˜1300-1400 cm⁻¹) to the G band (˜1550-1650 cm⁻¹). Thus, ID/IG is a measure of graphitic nature in carbon, and is determined from direct peak intensity, or by deconvolution, in the latter case, additional deconvoluted peaks may include D₄ (˜1000-1200 cm⁻¹) and D₃ (˜1450-1550 cm⁻¹). Without being bound by theory, the D₄ and/or D₃ bands are present in highly defective carbons like carbon black, and relate to amorphous carbon and/or hydrocarbon and/or or aliphatic moieties connected on graphitic basic structural units.

### BRIEF SUMMARY

Silicon-carbon composite materials with enhanced electrochemical properties and performance, and their related processes, are disclosed that overcome the challenges for providing amorphous nano-sized silicon entrained within porous carbon. Compared to other, inferior materials and processes described in the prior art, the materials and processes disclosed herein find superior utility in various applications, including energy storage devices such as lithium ion batteries.

### BRIEF DESCRIPTION OF THE DRAWINGS

FIG. 1. Relationship between Z and average Coulombic efficiency for various silicon-carbon composite materials.

FIG. 2. Differential capacity vs voltage plot for Silicon-Carbon Composite 3 from 2^{nd} cycle using a half-cell.

FIG. 3. Differential capacity vs voltage plot for Silicon-Carbon Composite 3 from 2^{nd} cycle to 5^{th} cycle using a half-cell.

FIG. 4. dQ/dV vs V plot for various silicon-carbon composite materials.

FIG. 5. Example of Calculation of φ for Silicon-Carbon Composite 3.

FIG. 6. Z vs φ plot for various silicon-carbon composite materials.

FIG. 7. Raman spectra of Carbon Scaffold Sample 11 and Sample 15.

FIG. 8. Raman spectra of Carbon Scaffold Sample 12 and Sample 10.

FIG. 9. Raman spectra of Carbon Scaffold Sample 13 and Sample 14.

FIG. 10. Surface area of carbon scaffold samples before and after heat treatments at various temperatures.

### DETAILED DESCRIPTION

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### A. Porous Scaffold Materials

For the purposes of embodiments of the current invention, a porous scaffold may be used, into which silicon is to be impregnated. In this context, the porous scaffold can comprise various materials. In some embodiments the porous scaffold material primarily comprises carbon, for example hard carbon. Other allotropes of carbon are also envisioned in other embodiments, for example, graphite, amorphous carbon, diamond, C60, carbon nanotubes (e.g., single and/or multi-walled), graphene and/or carbon fibers. The introduction of porosity into the carbon material can be achieved by a variety of means. For instance, the porosity in the carbon material can be achieved by modulation of polymer precursors, and/or processing conditions to create said porous carbon material, and described in detail in the subsequent section.

In other embodiments, the porous scaffold comprises a polymer material. To this end, a wide variety of polymers are envisioned in various embodiments to have utility, including, but not limited to, inorganic polymer, organic polymers, and addition polymers. Examples of inorganic polymers in this context includes, but are not limited to homochain polymers of silicon-silicon such as polysilanes, silicon carbide, polygermanes, and polystannanes. Additional examples of inorganic polymers includes, but are not limited to, heterochain polymers such as polyborazylenes, polysiloxanes like polydimethylsiloxane (PDMS), polymethylhydrosiloxane (PMHS) and polydiphenylsiloxane, polysilazanes like perhydridopolysilazane (PHPS), polyphosphazenes and poly(dichlorophosphazenes), polyphosphates, polythiazyls, and polysulfides. Examples of organic polymers includes, but are not limited to, low density polyethylene (LDPE), high density polyethylene (HDPE), polypropylene (PP), polyvinyl chloride (PVC), polystyrene (PS), nylon, nylon 6, nylon 6,6, teflon (Polytetrafluoroethylene), thermoplastic polyurethanes (TPU), polyureas, poly(lactide), poly(glycolide) and combinations thereof, phenolic resins, polyamides, polyaramids, polyethylene terephthalate, polychloroprene, polyacrylonitrile, polyaniline, polyimide, poly(3,4-ethylenedioxythiophene) polystyrene sulfonate (PDOT:PSS), and others known in the arts. The organic polymer can be synthetic or natural in origin. In some embodiments, the polymer is a polysaccharide, such as starch, cellulose, cellobiose, amylose, amylpectin, gum Arabic, lignin, and the like. In some embodiments, the polysaccharide is derived from the carmelization of mono- or oligomeric sugars, such as fructose, glucose, sucrose, maltose, raffinose, and the like.

In certain embodiments, the porous scaffold polymer material comprises a coordination polymer. Coordination polymers in this context include, but are not limited to, metal organic frameworks (MOFs). Techniques for production of MOFs, as well as exemplary species of MOFs, are known and described in the art (“The Chemistry and Applications of Metal-Organic Frameworks, Hiroyasu Furukawa et al. Science 341, (2013); DOI: 10.1126/science.1230444). Examples of MOFs in the context include, but are not limited to, Basolite™ materials and zeolitic imidazolate frameworks (ZIFs).

Concomitant with the myriad variety of polymers envisioned with the potential to provide a porous substrate, various processing approaches are envisioned in various embodiments to achieve said porosity. In this context, general methods for imparting porosity into various materials are myriad, as known in the art, including, but certainly not limited to, methods involving emulsification, micelle creation, gasification, dissolution followed by solvent removal (for example, lyophilization), axial compaction and sintering, gravity sintering, powder rolling and sintering, isostatic compaction and sintering, metal spraying, metal coating and sintering, metal injection molding and sintering, and the like. Other approaches to create a porous polymeric material, including creation of a porous gel, such as a freeze dried gel, aerogel, and the like are also envisioned.

In certain embodiments, the porous scaffold material comprises a porous ceramic material. In certain embodiments, the porous scaffold material comprises a porous ceramic foam. In this context, general methods for imparting porosity into ceramic materials are varied, as known in the art, including, but certainly not limited to, creation of porous In this context, general methods and materials suitable for comprising the porous ceramic include, but are not limited to, porous aluminum oxide, porous zirconia toughened alumina, porous partially stabilized zirconia, porous alumina, porous sintered silicon carbide, sintered silicon nitride, porous cordierite, porous zirconium oxide, clay-bound silicon carbide, and the like.

In certain embodiments, the porous scaffold comprises porous silica or other silicon material containing oxygen. The creation of silicon gels, including sol gels, and other porous silica materials is known in the art.

In certain embodiments, the porous material comprises a porous metal. Suitable metals in this regard include, but are not limited to porous aluminum, porous steel, porous nickel, porous Inconcel, porous Hasteloy, porous titanium, porous copper, porous brass, porous gold, porous silver, porous germanium, and other metals capable of being formed into porous structures, as known in the art. In some embodiments, the porous scaffold material comprises a porous metal foam. The types of metals and methods to manufacture related to same are known in the art. Such methods include, but are not limited to, casting (including foaming, infiltration, and lost-foam casting), deposition (chemical and physical), gas-eutectic formation, and powder metallurgy techniques (such as powder sintering, compaction in the presence of a foaming agent, and fiber metallurgy techniques).

### B. Porous Carbon Scaffold

Methods for preparing porous carbon materials from polymer precursors are known in the art. For example, methods for preparation of carbon materials are described in U.S. Pat. Nos. 7,723,262, 8,293,818, 8,404,384, 8,654,507, 8,916,296, 9,269,502, 10,590,277, and U.S. patent application Ser. No. 16/745,197, the full disclosures of which are hereby incorporated by reference in their entireties for all purposes.

Accordingly, in one embodiment the present disclosure provides a method for preparing any of the carbon materials or polymer gels described above. The carbon materials may be synthesized through pyrolysis of either a single precursor, for example a saccharide material such as sucrose, fructose, glucose, dextrin, maltodextrin, starch, amylopectin, amlyose, lignin, gum Arabic, and other saccharides known in the art, and combinations thereof. Alternatively, the carbon materials may be synthesized through pyrolysis of a complex resin, for instance formed using a sol-gel method using polymer precursors such as phenol, resorcinol, bisphenol A, urea, melamine, and other suitable compounds known in the art, and combinations thereof, in a suitable solvent such as water, ethanol, methanol, and other solvents known in the art, and combinations thereof, with cross-linking agents such as formaldehyde, hexamethylenetetramine, furfural, and other cross-lining agents known in the art, and combinations thereof. The resin may be acid or basic, and may contain a catalyst. The catalyst may be volatile or non-volatile. The pyrolysis temperature and dwell time can vary as known in the art.

In some embodiments, the methods comprise preparation of a polymer gel by a sol gel process, condensation process or crosslinking process involving monomer precursor(s) and a crosslinking agent, two existing polymers and a crosslinking agent or a single polymer and a crosslinking agent, followed by pyrolysis of the polymer gel. The polymer gel may be dried (e.g., freeze dried) prior to pyrolysis; however drying is not necessarily required.

The target carbon properties can be derived from a variety of polymer chemistries provided the polymerization reaction produces a resin/polymer with the necessary carbon backbone. Different polymer families include novolacs, resoles, acrylates, styrenics, ureathanes, rubbers (neoprenes, styrene-butadienes, etc.), nylons, etc. The preparation of any of these polymer resins can occur via a number of different processes including sol gel, emulsion/suspension, solid state, solution state, melt state, etc for either polymerization and crosslinking processes.

In some embodiments an electrochemical modifier is incorporated into the material as polymer. For example, the organic or carbon containing polymer, RF for example, is copolymerized with the polymer, which contains the electrochemical modifier. In one embodiment, the electrochemical modifier-containing polymer contains silicon. In one embodiment the polymer is tetraethylorthosiliane (TEOS). In one embodiment, a TEOS solution is added to the RF solution prior to or during polymerization. In another embodiment the polymer is a polysilane with organic side groups. In some cases these side groups are methyl groups, in other cases these groups are phenyl groups, in other cases the side chains include phenyl, pyrol, acetate, vinyl, siloxane fragments. In some cases the side chain includes a group 14 element (silicon, germanium, tin or lead). In other cases the side chain includes a group 13 element (boron, aluminum, boron, gallium, indium). In other cases the side chain includes a group 15 element (nitrogen, phosphorous, arsenic). In other cases the side chain includes a group 16 element (oxygen, sulfur, selenium).

In another embodiment the electrochemical modifier comprises a silole. In some cases it is a phenol-silole or a silafluorene. In other cases it is a poly-silole or a poly-silafluorene. In some cases the silicon is replaced with germanium (germole or germafluorene), tin (stannole or stannaflourene) nitrogen (carbazole) or phosphorous (phosphole, phosphafluorene). In all cases the heteroatom containing material can be a small molecule, an oligomer or a polymer. Phosphorous atoms may or may not be also bonded to oxygen.

In some embodiments the reactant comprises phosphorous. In certain other embodiments, the phosphorus is in the form of phosphoric acid. In certain other embodiments, the phosphorus can be in the form of a salt, wherein the anion of the salt comprises one or more phosphate, phosphite, phosphide, hydrogen phosphate, dihydrogen phosphate, hexafluorophosphate, hypophosphite, polyphosphate, or pyrophosphate ions, or combinations thereof. In certain other embodiments, the phosphorus can be in the form of a salt, wherein the cation of the salt comprises one or more phosphonium ions. The non-phosphate containing anion or cation pair for any of the above embodiments can be chosen for those known and described in the art. In the context, exemplary cations to pair with phosphate-containing anions include, but are not limited to, ammonium, tetraethylammonium, and tetramethylammonium ions. In the context, exemplary anions to pair with phosphate-containing cations include, but are not limited to, carbonate, dicarbonate, and acetate ions.

In some embodiments, the catalyst comprises a basic volatile catalyst. For example, in one embodiment, the basic volatile catalyst comprises ammonium carbonate, ammonium bicarbonate, ammonium acetate, ammonium hydroxide, or combinations thereof. In a further embodiment, the basic volatile catalyst is ammonium carbonate. In another further embodiment, the basic volatile catalyst is ammonium acetate.

In still other embodiments, the method comprises admixing an acid. In certain embodiments, the acid is a solid at room temperature and pressure. In some embodiments, the acid is a liquid at room temperature and pressure. In some embodiments, the acid is a liquid at room temperature and pressure that does not provide dissolution of one or more of the other polymer precursors.

The acid may be selected from any number of acids suitable for the polymerization process. For example, in some embodiments the acid is acetic acid and in other embodiments the acid is oxalic acid. In further embodiments, the acid is mixed with the first or second solvent in a ratio of acid to solvent of 99:1, 90:10, 75:25, 50:50, 25:75, 20:80, 10:90 or 1:99. In other embodiments, the acid is acetic acid and the first or second solvent is water. In other embodiments, acidity is provided by adding a solid acid.

The total content of acid in the mixture can be varied to alter the properties of the final product. In some embodiments, the acid is present from about 1% to about 50% by weight of mixture. In other embodiments, the acid is present from about 5% to about 25%. In other embodiments, the acid is present from about 10% to about 20%, for example about 10%, about 15% or about 20%.

In certain embodiments, the polymer precursor components are blended together and subsequently held for a time and at a temperature sufficient to achieve polymerization. One or more of the polymer precursor components can have particle size less than about 20 mm in size, for example less than 10 mm, for example less than 7 mm, for example, less than 5 mm, for example less than 2 mm, for example less than 1 mm, for example less than 100 microns, for example less than 10 microns. In some embodiments, the particle size of one or more of the polymer precursor components is reduced during the blending process.

The blending of one or more polymer precursor components in the absence of solvent can be accomplished by methods described in the art, for example ball milling, jet milling, Fritsch milling, planetary mixing, and other mixing methodologies for mixing or blending solid particles while controlling the process conditions (e.g., temperature). The mixing or blending process can be accomplished before, during, and/or after (or combinations thereof) incubation at the reaction temperature.

Reaction parameters include aging the blended mixture at a temperature and for a time sufficient for the one or more polymer precursors to react with each other and form a polymer. In this respect, suitable aging temperature ranges from about room temperature to temperatures at or near the melting point of one or more of the polymer precursors. In some embodiments, suitable aging temperature ranges from about room temperature to temperatures at or near the glass transition temperature of one or more of the polymer precursors. For example, in some embodiments the solvent free mixture is aged at temperatures from about 20° C. to about 600° C., for example about 20° C. to about 500° C., for example about 20° C. to about 400° C., for example about 20° C. to about 300° C., for example about 20° C. to about 200° C. In certain embodiments, the solvent free mixture is aged at temperatures from about 50 to about 250° C.

The reaction duration is generally sufficient to allow the polymer precursors to react and form a polymer, for example the mixture may be aged anywhere from 1 hour to 48 hours, or more or less depending on the desired result. Typical embodiments include aging for a period of time ranging from about 2 hours to about 48 hours, for example in some embodiments aging comprises about 12 hours and in other embodiments aging comprises about 4-8 hours (e.g., about 6 hours).

In certain embodiments, an electrochemical modifier is incorporated during the above described polymerization process. For example, in some embodiments, an electrochemical modifier in the form of metal particles, metal paste, metal salt, metal oxide or molten metal can be dissolved or suspended into the mixture from which the gel resin is produced

Exemplary electrochemical modifiers for producing composite materials may fall into one or more than one of the chemical classifications. In some embodiments, the electrochemical modifier is a lithium salt, for example, but not limited to, lithium fluoride, lithium chloride, lithium carbonate, lithium hydroxide, lithium benzoate, lithium bromide, lithium formate, lithium hexafluorophosphate, lithium iodate, lithium iodide, lithium perchlorate, lithium phosphate, lithium sulfate, lithium tetraborate, lithium tetrafluoroborate, and combinations thereof.

In certain embodiments, the electrochemical modifier comprises a metal, and exemplary species includes, but are not limited to aluminum isoproproxide, manganese acetate, nickel acetate, iron acetate, tin chloride, silicon chloride, and combinations thereof. In certain embodiments, the electrochemical modifier is a phosphate compound, including but not limited to phytic acid, phosphoric acid, ammonium dihydrogenphosphate, and combinations thereof. In certain embodiments, the electrochemical modifier comprises silicon, and exemplary species includes, but are not limited to silicon powders, silicon nanotubes, polycrystalline silicon, nanocrystalline silicon, amorphous silicon, porous silicon, nano sized silicon, nano-featured silicon, nano-sized and nano-featured silicon, silicyne, and black silicon, and combinations thereof.

Electrochemical modifiers can be combined with a variety of polymer systems through either physical mixing or chemical reactions with latent (or secondary) polymer functionality. Examples of latent polymer functionality include, but are not limited to, epoxide groups, unsaturation (double and triple bonds), acid groups, alcohol groups, amine groups, basic groups. Crosslinking with latent functionality can occur via heteroatoms (e.g. vulcanization with sulfur, acid/base/ring opening reactions with phosphoric acid), reactions with organic acids or bases (described above), coordination to transition metals (including but not limited to Ti, Cr, Mn, Fe, Co, Ni, Cu, Zn, Zr, Nb, Mo, Ag, Au), ring opening or ring closing reactions (rotaxanes, spiro compounds, etc).

Electrochemical modifiers can also be added to the polymer system through physical blending. Physical blending can include but is not limited to melt blending of polymers and/or co-polymers, the inclusion of discrete particles, chemical vapor deposition of the electrochemical modifier and coprecipitation of the electrochemical modifier and the main polymer material.

In some instances the electrochemical modifier can be added via a metal salt solid, solution, or suspension. The metal salt solid, solution or suspension may comprise acids and/or alcohols to improve solubility of the metal salt. In yet another variation, the polymer gel (either before or after an optional drying step) is contacted with a paste comprising the electrochemical modifier. In yet another variation, the polymer gel (either before or after an optional drying step) is contacted with a metal or metal oxide sol comprising the desired electrochemical modifier.

In addition to the above exemplified electrochemical modifiers, the composite materials may comprise one or more additional forms (i.e., allotropes) of carbon. In this regard, it has been found that inclusion of different allotropes of carbon such as graphite, amorphous carbon, conductive carbon, carbon black, diamond, C60, carbon nanotubes (e.g., single and/or multi-walled), graphene and/or carbon fibers into the composite materials is effective to optimize the electrochemical properties of the composite materials. The various allotropes of carbon can be incorporated into the carbon materials during any stage of the preparation process described herein. For example, during the solution phase, during the gelation phase, during the curing phase, during the pyrolysis phase, during the milling phase, or after milling. In some embodiments, the second carbon form is incorporated into the composite material by adding the second carbon form before or during polymerization of the polymer gel as described in more detail herein. The polymerized polymer gel containing the second carbon form is then processed according to the general techniques described herein to obtain a carbon material containing a second allotrope of carbon.

In a preferred embodiment, the carbon is produced from precursors with little or no solvent required for processing (solvent free). The structure of the polymer precursors suitable for use in a low solvent or essentially solvent free reaction mixture is not particularly limited, provided that the polymer precursor is capable of reacting with another polymer precursor or with a second polymer precursor to form a polymer. Polymer precursors include amine-containing compounds, alcohol-containing compounds and carbonyl-containing compounds, for example in some embodiments the polymer precursors are selected from an alcohol, a phenol, a polyalcohol, a sugar, an alkyl amine, an aromatic amine, an aldehyde, a ketone, a carboxylic acid, an ester, a urea, an acid halide and an isocyanate.

In one embodiment employing a low or essentially solvent free reaction mixture, the method comprises use of a first and second polymer precursor, and in some embodiments the first or second polymer precursor is a carbonyl containing compound and the other of the first or second polymer precursor is an alcohol containing compound. In some embodiments, a first polymer precursor is a phenolic compound and a second polymer precursor is an aldehyde compound (e.g., formaldehyde). In one embodiment, of the method the phenolic compound is phenol, resorcinol, catechol, hydroquinone, phloroglucinol, or a combination thereof; and the aldehyde compound is formaldehyde, acetaldehyde, propionaldehyde, butyraldehyde, benzaldehyde, cinnamaldehyde, or a combination thereof. In a further embodiment, the phenolic compound is resorcinol, phenol or a combination thereof, and the aldehyde compound is formaldehyde. In yet further embodiments, the phenolic compound is resorcinol and the aldehyde compound is formaldehyde. In some embodiments, the polymer precursors are alcohols and carbonyl compounds (e.g., resorcinol and aldehyde) and they are present in a ratio of about 0.5:1.0, respectively.

The polymer precursor materials suitable for low or essentially solvent free reaction mixture as disclosed herein include (a) alcohols, phenolic compounds, and other mono- or polyhydroxy compounds and (b) aldehydes, ketones, and combinations thereof. Representative alcohols in this context include straight chain and branched, saturated and unsaturated alcohols. Suitable phenolic compounds include polyhydroxy benzene, such as a dihydroxy or trihydroxy benzene. Representative polyhydroxy benzenes include resorcinol (i.e., 1,3-dihydroxy benzene), catechol, hydroquinone, and phloroglucinol. Other suitable compounds in this regard are bisphenols, for instance, bisphenol A. Mixtures of two or more polyhydroxy benzenes can also be used. Phenol (monohydroxy benzene) can also be used. Representative polyhydroxy compounds include sugars, such as glucose, sucrose, fructose, chitin and other polyols, such as mannitol. Aldehydes in this context include: straight chain saturated aldehydes such as methanal (formaldehyde), ethanal (acetaldehyde), propanal (propionaldehyde), butanal (butyraldehyde), and the like; straight chain unsaturated aldehydes such as ethenone and other ketenes, 2-propenal (acrylaldehyde), 2-butenal (crotonaldehyde), 3 butenal, and the like; branched saturated and unsaturated aldehydes; and aromatic-type aldehydes such as benzaldehyde, salicylaldehyde, hydrocinnamaldehyde, and the like. Suitable ketones include: straight chain saturated ketones such as propanone and 2 butanone, and the like; straight chain unsaturated ketones such as propenone, 2 butenone, and 3 butenone (methyl vinyl ketone) and the like; branched saturated and unsaturated ketones; and aromatic-type ketones such as methyl benzyl ketone (phenylacetone), ethyl benzyl ketone, and the like. The polymer precursor materials can also be combinations of the precursors described above.

In some embodiments, one polymer precursor in the low or essentially solvent free reaction mixture is an alcohol-containing species and another polymer precursor is a carbonyl-containing species. The relative amounts of alcohol-containing species (e.g., alcohols, phenolic compounds and mono- or poly-hydroxy compounds or combinations thereof) reacted with the carbonyl containing species (e.g. aldehydes, ketones or combinations thereof) can vary substantially. In some embodiments, the ratio of alcohol-containing species to aldehyde species is selected so that the total moles of reactive alcohol groups in the alcohol-containing species is approximately the same as the total moles of reactive carbonyl groups in the aldehyde species. Similarly, the ratio of alcohol-containing species to ketone species may be selected so that the total moles of reactive alcohol groups in the alcohol containing species is approximately the same as the total moles of reactive carbonyl groups in the ketone species. The same general 1:1 molar ratio holds true when the carbonyl-containing species comprises a combination of an aldehyde species and a ketone species.

In other embodiments, the polymer precursor in the low or essentially solvent free reaction mixture is a urea or an amine containing compound. For example, in some embodiments the polymer precursor is urea, melamine, hexamethylenetetramine (HMT) or combination thereof. Other embodiments include polymer precursors selected from isocyanates or other activated carbonyl compounds such as acid halides and the like.

Some embodiments of the disclosed methods include preparation of low or solvent-free polymer gels (and carbon materials) comprising electrochemical modifiers. Such electrochemical modifiers include, but are not limited to nitrogen, silicon, and sulfur. In other embodiments, the electrochemical modifier comprises fluorine, iron, tin, silicon, nickel, aluminum, zinc, or manganese. The electrochemical modifier can be included in the preparation procedure at any step. For example, in some the electrochemical modifier is admixed with the mixture, the polymer phase or the continuous phase.

The blending of one or more polymer precursor components in the absence of solvent can be accomplished by methods described in the art, for example ball milling, jet milling, Fritsch milling, planetary mixing, and other mixing methodologies for mixing or blending solid particles while controlling the process conditions (e.g., temperature). The mixing or blending process can be accomplished before, during, and/or after (or combinations thereof) incubation at the reaction temperature.

Reaction parameters include aging the blended mixture at a temperature and for a time sufficient for the one or more polymer precursors to react with each other and form a polymer. In this respect, suitable aging temperature ranges from about room temperature to temperatures at or near the melting point of one or more of the polymer precursors. In some embodiments, suitable aging temperature ranges from about room temperature to temperatures at or near the glass transition temperature of one or more of the polymer precursors. For example, in some embodiments the solvent free mixture is aged at temperatures from about 20° C. to about 600° C., for example about 20° C. to about 500° C., for example about 20° C. to about 400° C., for example about 20° C. to about 300° C., for example about 20° C. to about 200° C. In certain embodiments, the solvent free mixture is aged at temperatures from about 50 to about 250° C.

The porous carbon material can be achieved via pyrolysis of a polymer produced from precursors materials as described above. In some embodiments, the porous carbon material comprises an amorphous activated carbon that is produced by pyrolysis, physical or chemical activation, or combination thereof in either a single process step or sequential process steps.

The temperature and dwell time of pyrolysis can be varied, for example the dwell time van vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200 to 300 C, from 250 to 350 C, from 350 C to 450 C, from 450 C to 550 C, from 540 C to 650 C, from 650 C to 750 C, from 750 C to 850 C, from 850 C to 950 C, from 950 C to 1050 C, from 1050 C to 1150 C, from 1150 C to 1250 C. In some embodiments, the pyrolysis temperature varies from 650 C to 1100 C. The pyrolysis can be accomplished in an inert gas, for example nitrogen, or argon.

In some embodiments, an alternate gas is used to further accomplish carbon activation. In certain embodiments, pyrolysis and activation are combined. Suitable gases for accomplishing carbon activation include, but are not limited to, carbon dioxide, carbon monoxide, water (steam), air, oxygen, and further combinations thereof. The temperature and dwell time of activation can be varied, for example the dwell time van vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200 to 300 C, from 250 to 350 C, from 350 C to 450 C, from 450 C to 550 C, from 540 C to 650 C, from 650 C to 750 C, from 750 C to 850 C, from 850 C to 950 C, from 950 C to 1050 C, from 1050 C to 1150 C, from 1150 C to 1250 C. In some embodiments, the temperature for combined pyrolysis and activation varies from 650 C to 1100 C.

In some embodiments, combined pyrolysis and activation is carried out to prepare the porous carbon scaffold. In such embodiments, the process gas can remain the same during process, or the composition of process gas may be varied during processing. In some embodiments, the addition of an activation gas such as CO2, steam, or combination thereof, is added to the process gas following sufficient temperature and time to allow for pyrolysis of the solid carbon precursors.

Suitable gases for accomplishing carbon activation include, but are not limited to, carbon dioxide, carbon monoxide, water (steam), air, oxygen, and further combinations thereof. The temperature and dwell time of activation can be varied, for example the dwell time van vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200 to 300 C, from 250 to 350 C, from 350 C to 450 C, from 450 C to 550 C, from 540 C to 650 C, from 650 C to 750 C, from 750 C to 850 C, from 850 C to 950 C, from 950 C to 1050 C, from 1050 C to 1150 C, from 1150 C to 1250 C. In some embodiments, the activation temperature varies from 650 C to 1100 C.

Either prior to the pyrolysis, and/or after pyrolysis, and/or after activation, the carbon may be subjected to a particle size reduction. The particle size reduction can be accomplished by a variety of techniques known in the art, for example by jet milling in the presence of various gases including air, nitrogen, argon, helium, supercritical steam, and other gases known in the art. Other particle size reduction methods, such as grinding, ball milling, jet milling, water jet milling, and other approaches known in the art are also envisioned.

The porous carbon scaffold may be in the form of particles. The particle size and particle size distribution can be measured by a variety of techniques known in the art, and can be described based on fractional volume. In this regard, the Dv,50 of the carbon scaffold may be between 10 nm and 10 mm, for example between 100 nm and 1 mm, for example between 1 um and 100 um, for example between 2 um and 50 um, example between 3 um and 30 um, example between 4 um and 20 um, example between 5 um and 10 um. In certain embodiments, the Dv,50 is less than 1 mm, for example less than 100 um, for example less than 50 um, for example less than 30 um, for example less than 20 um, for example less than 10 um, for example less than 8 um, for example less than 5 um, for example less than 3 um, for example less than 1 um. In certain embodiments, the Dv,100 is less than 1 mm, for example less than 100 um, for example less than 50 um, for example less than 30 um, for example less than 20 um, for example less than 10 um, for example less than 8 um, for example less than 5 um, for example less than 3 um, for example less than 1 um. In certain embodiments, the Dv,99 is less than 1 mm, for example less than 100 um, for example less than 50 um, for example less than 30 um, for example less than 20 um, for example less than 10 um, for example less than 8 um, for example less than 5 um, for example less than 3 um, for example less than 1 um. In certain embodiments, the Dv,90 is less than 1 mm, for example less than 100 um, for example less than 50 um, for example less than 30 um, for example less than 20 um, for example less than 10 um, for example less than 8 um, for example less than 5 um, for example less than 3 um, for example less than 1 um. In certain embodiments, the Dv,0 is greater than 10 nm, for example greater than 100 nm, for example greater than 500 nm, for example greater than 1 um, for example greater than 2 um, for example greater than 5 um, for example greater than 10 um. In certain embodiments, the Dv,1 is greater than 10 nm, for example greater than 100 nm, for example greater than 500 nm, for example greater than 1 um, for example greater than 2 um, for example greater than 5 um, for example greater than 10 um. In certain embodiments, the Dv,10 is greater than 10 nm, for example greater than 100 nm, for example greater than 500 nm, for example greater than 1 um, for example greater than 2 um, for example greater than 5 um, for example greater than 10 um.

In some embodiments, the surface area of the porous carbon scaffold can comprise a surface area greater than 400 m2/g, for example greater than 500 m2/g, for example greater than 750 m2/g, for example greater than 1000 m2/g, for example greater than 1250 m2/g, for example greater than 1500 m2/g, for example greater than 1750 m2/g, for example greater than 2000 m2/g, for example greater than 2500 m2/g, for example greater than 3000 m2/g. In other embodiments, the surface area of the porous carbon scaffold can be less than 500 m2/g. In some embodiments, the surface area of the porous carbon scaffold is between 200 and 500 m2/g. In some embodiments, the surface area of the porous carbon scaffold is between 100 and 200 m2/g. In some embodiments, the surface area of the porous carbon scaffold is between 50 and 100 m2/g. In some embodiments, the surface area of the porous carbon scaffold is between 10 and 50 m2/g. In some embodiments, the surface area of the porous carbon scaffold can be less than 10 m2/g.

In some embodiments, the pore volume of the porous carbon scaffold is greater than 0.4 cm3/g, for example greater than 0.5 cm3/g, for example greater than 0.6 cm3/g, for example greater than 0.7 cm3/g, for example greater than 0.8 cm3/g, for example greater than 0.9 cm3/g, for example greater than 1.0 cm3/g, for example greater than 1.1 cm3/g, for example greater than 1.2 cm3/g, for example greater than 1.4 cm3/g, for example greater than 1.6 cm3/g, for example greater than 1.8 cm3/g, for example greater than 2.0 cm3/g. In other embodiments, the pore volume of the porous silicon scaffold is less than 0.5 cm3, for example between 0.1 cm3/g and 0.5 cm3/g. In certain other embodiments, the pore volume of the porous silicon scaffold is between 0.01 cm3/g and 0.1 cm3/g.

In some other embodiments, the porous carbon scaffold is an amorphous activated carbon with a pore volume between 0.2 and 2.0 cm3/g. In certain embodiments, the carbon is an amorphous activated carbon with a pore volume between 0.4 and 1.5 cm3/g. In certain embodiments, the carbon is an amorphous activated carbon with a pore volume between 0.5 and 1.2 cm3/g. In certain embodiments, the carbon is an amorphous activated carbon with a pore volume between 0.6 and 1.0 cm3/g.

In some other embodiments, the porous carbon scaffold comprises a tap density of less than 1.0 g/cm3, for example less than 0.8 g/cm3, for example less than 0.6 g/cm3, for example less than 0.5 g/cm3, for example less than 0.4 g/cm3, for example less than 0.3 g/cm3, for example less than 0.2 g/cm3, for example less than 0.1 g/cm3.

The surface functionality of the porous carbon scaffold can vary. One property which can be predictive of surface functionality is the pH of the porous carbon scaffold. The presently disclosed porous carbon scaffolds comprise pH values ranging from less than 1 to about 14, for example less than 5, from 5 to 8 or greater than 8. In some embodiments, the pH of the porous carbon is less than 4, less than 3, less than 2 or even less than 1. In other embodiments, the pH of the porous carbon is between about 5 and 6, between about 6 and 7, between about 7 and 8 or between 8 and 9 or between 9 and 10. In still other embodiments, the pH is high and the pH of the porous carbon ranges is greater than 8, greater than 9, greater than 10, greater than 11, greater than 12, or even greater than 13.

The pore volume distribution of the porous carbon scaffold can vary. For example, the % micropores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable micropore volume in the porous carbon scaffold.

The mesopores comprising the porous carbon scaffold scaffold can vary. For example, the % mesopores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable mesopore volume in the porous carbon scaffold.

In some embodiments, the pore volume distribution of the porous carbon scaffold scaffold comprises more than 50% macropores, for example more than 60% macropores, for example more than 70% macropores, for example more than 80% macropores, for example more than 90% macropores, for example more than 95% macropores, for example more than 98% macropores, for example more than 99% macropores, for example more than 99.5% macropores, for example more than 99.9% macropores.

In certain preferred embodiments, the pore volume of the porous carbon scaffold comprises a blend of micropores, mesopores, and macropores. Accordingly, in certain embodiments, the porous carbon scaffold comprises 0-20% micropores, 30-70% mesopores, and less than 10% macropores. In certain other embodiments, the porous carbon scaffold comprises 0-20% micropores, 0-20% mesopores, and 70-95% macropores. In certain other embodiments, the porous carbon scaffold comprises 20-50% micropores, 50-80% mesopores, and 0-10% macropores. In certain other embodiments, the porous carbon scaffold comprises 40-60% micropores, 40-60% mesopores, and 0-10% macropores. In certain other embodiments, the porous carbon scaffold comprises 80-95% micropores, 0-10% mesopores, and 0-10% macropores. In certain other embodiments, the porous carbon scaffold comprises 0-10% micropores, 30-50% mesopores, and 50-70% macropores. In certain other embodiments, the porous carbon scaffold comprises 0-10% micropores, 70-80% mesopores, and 0-20% macropores. In certain other embodiments, the porous carbon scaffold comprises 0-20% micropores, 70-95% mesopores, and 0-10% macropores. In certain other embodiments, the porous carbon scaffold comprises 0-10% micropores, 70-95% mesopores, and 0-20% macropores.

In certain embodiments, the % of pore volume in the porous carbon scaffold representing pores between 100 and 1000 A (10 and 100 nm) comprises greater than 30% of the total pore volume, for example greater than 40% of the total pore volume, for example greater than 50% of the total pore volume, for example greater than 60% of the total pore volume, for example greater than 70% of the total pore volume, for example greater than 80% of the total pore volume, for example greater than 90% of the total pore volume, for example greater than 95% of the total pore volume, for example greater than 98% of the total pore volume, for example greater than 99% of the total pore volume, for example greater than 99.5% of the total pore volume, for example greater than 99.9% of the total pore volume.

In certain embodiments, the pycnometry density of the porous carbon scaffold ranges from about 1 g/cc to about 3 g/cc, for example from about 1.5 g/cc to about 2.3 g/cc. In other embodiments, the skeletal density ranges from about 1.5 cc/g to about 1.6 cc/g, from about 1.6 cc/g to about 1.7 cc/g, from about 1.7 cc/g to about 1.8 cc/g, from about 1.8 cc/g to about 1.9 cc/g, from about 1.9 cc/g to about 2.0 cc/g, from about 2.0 cc/g to about 2.1 cc/g, from about 2.1 cc/g to about 2.2 cc/g or from about 2.2 cc/g to about 2.3 cc/g, from about 2.3 cc to about 2.4 cc/g, for example from about 2.4 cc/g to about 2.5 cc/g.

### C. Silicon Production Via Chemical Vapor Infiltration (CVI)

Chemical vapor deposition (CVD) is a process wherein a substrate provides a solid surface comprising the first component of the composite, and the gas thermally decomposes on this solid surface to provide the second component of composite. Such a CVD approach can be employed, for instance, to create Si—C composite materials wherein the silicon is coating on the outside surface of silicon particles. Alternatively, chemical vapor infiltration (CVI) is a process wherein a substrate provides a porous scaffold comprising the first component of the composite, and the gas thermally decomposes on into the porosity (into the pores) of the porous scaffold material to provide the second component of composite.

In an embodiment, silicon is created within the pores of the porous carbon scaffold by subjecting the porous carbon particles to a silicon containing precursor gas at elevated temperature and the presence of a silicon-containing gas, preferably silane, in order to decompose said gas into silicon. In some embodiments, the silicon containing gas may comprise a higher-order silane (such as di-, tri-, and/or tetrasilane), chlorosilane(s) (such as mono-,di-, tri-, and tetrachlorosilane) or mixtures thereof.

The silicon containing precursor gas can be mixed with other inert gas(es) for example, nitrogen gas, or hydrogen gas, or argon gas, or helium gas, or combinations thereof. The temperature and time of processing can be varied, for example the temperature can be between 200 and 900 C, for example between 200 and 250 C, for example between 250 and 300 C, for example between 300 and 350 C, for example between 300 and 400 C, for example between 350 and 450 C, for example between 350 and 400 C, for example between 400 and 500 C, for example between 500 and 600 C, for example between 600 and 700 C, for example between 700 and 800 C, for example between 800 and 900 C, for example between 600 and 1100 C.

The mixture of gas can comprise between 0.1 and 1% silane and remainder inert gas. Alternatively, the mixture of gas can comprise between 1% and 10% silane and remainder inert gas. Alternatively, the mixture of gas can comprise between 10% and 20% silane and remainder inert gas. Alternatively, the mixture of gas can comprise between 20% and 50% silane and remainder inert gas. Alternatively, the mixture of gas can comprise above 50% silane and remainder inert gas. Alternatively, the gas can essentially be 100% silane gas. Suitable inert gases include, but are not limited to, hydrogen, nitrogen, argon, and combinations thereof.

The pressure for the CVI process can be varied. In some embodiments, the pressure is atmospheric pressure. In some embodiments, the pressure is below atmospheric pressure. In some embodiments, the pressure is above atmospheric pressure.

### C. Physico- and Electrochemical Properties of Silicon-Carbon Composite

While not wishing to be bound by theory, it is believed that the nano sized silicon achieved as a result of filling in certain, desired pore volume structure of the porous carbon scaffold (for instance, silicon filling pores in the range of 5 to 1000 nm, or other range as disclosed elsewhere herein), along with the advantageous properties of the other components of the composite, including low surface area, low pycnometry density, yield composite materials having different and advantageous properties, for instance electrochemical performance when the composite comprises an anode of a lithium ion energy storage device.

In certain embodiments, the embedded silicon particles embedded within the composite comprise nano-sized features. The nano-sized features can have a characteristic length scale of preferably less than 1 um, preferably less than 300 nm, preferably less than 150 nm, preferably less than 100 nm, preferably less than 50 nm, preferably less than 30 nm, preferably less than 15 nm, preferably less than 10 nm, preferably less than 5 nm.

In certain embodiments, the silicon embedded within the composite is spherical in shape. In certain other embodiments, the porous silicon particles are non-spherical, for example rod-like, or fibrous in structure. In some embodiments, the silicon exists as a layer coating the inside of pores within the porous carbon scaffold. The depth of this silicon layer can vary, for example the depth can between 5 nm and 10 nm, for example between 5 nm and 20 nm, for example between 5 nm and 30 nm, for example between nm and 33 nm, for example between 10 nm and 30 nm, for example between 10 nm and 50 nm, for example between 10 nm and 100 nm, for example between 10 and 150 nm, for example between 50 nm and 150 nm, for example between 100 and 300 nm, for example between 300 and 1000 nm.

In some embodiments, the silicon embedded within the composite is nano sized, and resides within pores of the porous carbon scaffold. For example, the embedded silicon can be impregnated, deposited by CVI, or other appropriate process into pores within the porous carbon particle comprising pore sizes between 5 and 1000 nm, for example between 10 and 500 nm, for example between 10 and 200 nm, for example between 10 and 100 nm, for example between 33 and 150 nm, for example between and and 100 nm. Other ranges of carbon pores sizes with regards to fractional pore volume, whether micropores, mesopores, or macropores, are also envisioned.

Embodiments of the composite with extremely durable intercalation of lithium disclosed herein improves the properties of any number of electrical energy storage devices, for example lithium ion batteries. In some embodiments, the silicon-carbon composite disclosed herein exhibits a Z less than 10, for example a Z less than 5, for example a Z less than 4, for example a Z less than 3, for example a Z less than 2, for example a Z less than 1, for example a Z less than 0.1, for example a Z less than 0.01, for example a Z less than 0.001. In certain embodiments, the Z is zero.

In certain preferred embodiment, the silicon-carbon composite comprises desirably low Z in combination with another desired physicochemical and/or electrochemical property or in combination with more than one other desired physicochemical and/or electrochemical properties. Table 1 provides a description of certain embodiments for combination of properties for the silicon-carbon composite.

TABLE 1
Embodiments for silicon-carbon composite with embodied properties.

| | In some embodiments the silicon-carbon |
|---|---|
| | composite comprises . . . |
| Z | <10, <5, <4, <3, <2, <1, <0.1, <0.01, < 0.01, 0 |
| Surface Area | <100 m2/g, <50 m2/g, <30 m2/g, <20 m2/g, <10 m2/g, |
| | <5 m2/g, <4 m2/g, <3 m2/g, <2 m2/g, <1 m2/g; |
| First Cycle | >75%, >80%, >85%, >90%, >91%, >92%, >93%, |
| Efficiency | >94%, >95%, >96%, >97%, >98%, >99%; |
| Reversible | >1300 mAh/g, >1600 mAh/g, >1700 mAh/g, |
| Capacity | >1800 mAh/g, >1900 mAh/g, >2000 mAh/g, |
| | >2100 mAh/g, >2200 mAh/g, >2300 mAh/g, |
| | >2400 mAh/g, >2500 mAh/g, >2600 mAh/g, |
| | >2700 mAh/g, >2800 mAh/g, >2900 mAh/g, |
| | >3000 mAh/g; |
| | and/or |
| Silicon Content | 10%-90%, 15-85%, 20%-80%, 30%-70%, 40%-60%. |
| by weight | |

According to Table 1, the silicon-carbon composite may comprise combinations of various properties. For example, the silicon-carbon composite may comprise a Z less than 10, surface area less than 100 m2/g, a first cycle efficiency greater than 80%, and a reversible capacity of at least 1300 mAh/g. For example, the silicon-carbon composite may comprise a Z less than 10, surface area less than 100 m2/g, a first cycle efficiency greater than 80%, and a reversible capacity of at least 1600 mAh/g. For example, the silicon-carbon composite may comprise a Z less than 10, surface area less than 20 m2/g, a first cycle efficiency greater than 85%, and a reversible capacity of at least 1600 mAh/g. For example, the silicon-carbon composite may comprise a Z less than 10, surface area less than 10 m2/g, a first cycle efficiency greater than 85%, and a reversible capacity of at least 1600 mAh/g. For example, the silicon-carbon composite may comprise a Z less than 10, surface area less than 10 m2/g, a first cycle efficiency greater than 90%, and a reversible capacity of at least 1600 mAh/g. For example, the silicon-carbon composite may comprise a Z less than 10, surface area less than 10 m2/g, a first cycle efficiency greater than 90%, and a reversible capacity of at least 1800 mAh/g.

The silicon-carbon composite can comprise a combination of the aforementioned properties, in addition to also comprising a carbon scaffold comprising properties also described within this proposal. Accordingly, Table 2 provides a description of certain embodiments for combination of properties for the silicon-carbon composite.

TABLE 2
Embodiments for silicon-carbon composite with embodied properties.

| | In some embodiments the silicon-carbon |
|---|---|
| | composite comprises . . . |
| Z | <10, <5, <4, <3, <2, <1, <0.1, <0.01, <0.01, 0 |
| Surface Area | <100 m2/g, <50 m2/g, <30 m2/g, <20 m2/g, <10 m2/g, |
| | <5m2/g, < 4 m2/g, < 3 m2/g, < 2 m2/g, < 1 m2/g; |
| First Cycle | >75%, >80%, >85%, >90%, >91%, >92%, >93%, |
| Efficiency | >94%, >95%, >96%, >97%, >98%, >99%; |
| Reversible | >1300 mAh/g, >1600 mAh/g, >1700 mAh/g, |
| Capacity | >1800 mAh/g, >1900 mAh/g, >2000 mAh/g, |
| | >2100 mAh/g, >2200 mAh/g, >2300 mAh/g, |
| | >2400 mAh/g, >2500 mAh/g, >2600 mAh/g, |
| | >2700 mAh/g, >2800 mAh/g, >2900 mAh/g, |
| | >3000 mAh/g; |
| Silicon Content | 10%-90%, 15-85%, 20%-80%, 30%-70%, 40%-60%; |
| by weight | |
| Carbon | 0.1-1.5 cm3/g, 0.2-1.2 cm3/g, 0.3-1.1 cm3/g, |
| Scaffold pore | 0.4-1.0 cm3/g, 0.4-1.0 cm3/g, 0.5-1.0 cm3/g, |
| volume | 0.6-1.0 cm3/g, 0.5-0.9 cm3/g, 0.4-1.0 cm3/g, |
| | >0.1 cm3/g, >0.2 cm3/g, >0.4 cm3/g, >0.6 cm3/g, |
| | >0.8 cm3/g; |
| % silicon | 15%-25%, 25%-35%, 20%-40%, 25%-50%, |
| content | 30%-70%, 30%-60%, 60%-80%, 80%-100%; |
| Scaffold pore | <1 nm, 1-5 nm, 5-1000 nm, 10-500 nm, 10-200 nm, |
| size range | 10-100 nm, 33-150 nm, 20-100 nm; |
| Percentage of | >20%/>30%/>30%, <10/>30/>30, <5/>30/>30, |
| microporosity/ | <5/>40/>40, <1/>40/>40, <10/>70/>20, <10/>20/>70, |
| mesoporosity/ | >10/>10/>80, <10/>80/>10,<5/>70/>20, <5/>20/>70, |
| macroporosity | <5/>5/>80, <5/>80/>10, >80%/<20%/<20%, |
| expressed as | >70/<30/<10, >70/<30/<5, >70/<20/<10,>70/<10/<10, |
| percentage of | >70/<10/<5,>70/<5/<5, >80/<20/<10, >80/<20/<5, |
| total pore | >80/<20/<1, >80/<10/<10, >80/<10/<5,>80/<10/<1, |
| volume | >90/<10/<10, >90/<10/<5, >90/<10/<1, >90/<5/<1, |
| | >95/<5/<5, >90/<5/<1. and/or |
| I_{D}/I_{G} | >2.0, 1.0-2.0, 0.8-1.0, 0.8-0.9, 0.9-1.0, 0.6-0.8, 0.6-0.7, |
| | 0.7-0.8, 0.4-0.6, 0.4-0.5, 0.5-0.6, 0.2-0.4, 0.2-0.3, |
| | 0.3-0.4, 0.01-0.2, 0.01-0.1, 0.1-0.2, ≤0.7, ≤0.6, ≤0.5, |
| | ≤0.4, ≤0.3, ≤0.2, ≤0.1, ≤0.05, ≤0.01 |

As used herein, the percentage “microporosity,” “mesoporosity” and “macroporosity” refers to the percent of micropores, mesopores and macropores, respectively, as a percent of total pore volume. For example, a carbon scaffold having 90% microporosity is a carbon scaffold where 90% of the total pore volume of the carbon scaffold is formed by micropores.

According to Table 2, the silicon-carbon composite may comprise combinations of various properties. For example, the silicon-carbon composite may comprise a I_{D}/I_{G}≤0.7, a Z less than 10, surface area less than 100 m2/g, a first cycle efficiency greater than 80%, a reversible capacity of at least 1600 mAh/g, a silicon content of 15%-85%, a carbon scaffold total pore volume of 0.2-1.2 cm3/g wherein the scaffold pore volume comprises >80% micropores, <20% mesopores, and <10% macropores. For example, the silicon-carbon composite may comprise a I_{D}/I_{G}≤0.7, a Z less than 10, surface area less than 20 m2/g, a first cycle efficiency greater than 85%, and a reversible capacity of at least 1600 mAh/g, a silicon content of 15%-85%, a carbon scaffold total pore volume of 0.2-1.2 cm3/g wherein the scaffold pore volume comprises >80% micropores, <20% mesopores, and <10% macropores. For example, the silicon-carbon composite may comprise a I_{D}/I_{G}≤0.7, a Z less than 10, surface area less than 10 m2/g, a first cycle efficiency greater than 85%, and a reversible capacity of at least 1600 mAh/g, a silicon content of 15%-85%, a carbon scaffold total pore volume of 0.2-1.2 cm3/g wherein the scaffold pore volume comprises >80% micropores, <20% mesopores, and <10% macropores. For example, the silicon-carbon composite may comprise a I_{D}/I_{G}≤0.7, Z less than 10, surface area less than 10 m2/g, a first cycle efficiency greater than 90%, and a reversible capacity of at least 1600 mAh/g, a silicon content of 15%-85%, a carbon scaffold total pore volume of 0.2-1.2 cm3/g wherein the scaffold pore volume comprises >80% micropores, <20% mesopores, and <10% macropores. For example, the silicon-carbon composite may comprise a I_{D}/I_{G}≤0.7, a Z less than 10, surface area less than 10 m2/g, a first cycle efficiency greater than 90%, and a reversible capacity of at least 1800 mAh/g, a silicon content of 15%-85%, a carbon scaffold total pore volume of 0.2-1.2 cm3/g wherein the scaffold pore volume comprises >80% micropores, <20% mesopores, and <10% macropores.

Without being bound by theory, the filling of silicon within the pores of the porous carbon traps porosity within the porous carbon scaffold particle, resulting in inaccessible volume, for example volume that is inaccessible to nitrogen gas. Accordingly, the silicon-carbon composite material may exhibit a pycnometry density of less than 2.1 g/cm3, for example less than 2.0 g/cm3, for example less than 1.9 g/cm3, for example less than 1.8 g/cm3, for example less than 1.7 g/cm3, for example less than 1.6 g/cm3, for example less than 1.4 g/cm3, for example less than 1.2 g/cm3, for example less than 1.0 g/cm3.

In some embodiments, the silicon-carbon composite material may exhibit a pycnometry density between 1.7 g·cm3 and 2.1 g/cm3, for example between 1.7 g·cm3 and 1.8 g/cm3, between 1.8 g·cm3 and 1.9 g/cm3, for example between 1.9 g·cm3 and 2.0 g/cm3, for example between 2.0 g·cm3 and 2.1 g/cm3. In some embodiments, the silicon-carbon composite material may exhibit a pycnometry density between 1.8 g·cm3 and 2.1 g/cm3. In some embodiments, the silicon-carbon composite material may exhibit a pycnometry density between 1.8 g·cm3 and 2.0 g/cm3. In some embodiments, the silicon-carbon composite material may exhibit a pycnometry density between 1.9 g·cm3 and 2.1 g/cm3.

The pore volume of the composite material exhibiting extremely durable intercalation of lithium can range between 0.01 cm3/g and 0.2 cm3/g. In certain embodiments, the pore volume of the composite material can range between 0.01 cm3/g and 0.15 cm3/g, for example between 0.01 cm3/g and 0.1 cm3/g, for example between 0.01 cm3/g and 0.05 cm2/g.

The particle size distribution of the composite material exhibiting extremely durable intercalation of lithium is important to both determine power performance as well as volumetric capacity. As the packing improves, the volumetric capacity may increase. In one embodiment the distributions are either Gaussian with a single peak in shape, bimodal, or polymodal (>2 distinct peaks, for example trimodal). The properties of particle size of the composite can be described by the DO (smallest particle in the distribution), Dv50 (average particle size) and Dv100 (maximum size of the largest particle). The optimal combined of particle packing and performance will be some combination of the size ranges below. The particle size reduction in the such embodiments can be carried out as known in the art, for example by jet milling in the presence of various gases including air, nitrogen, argon, helium, supercritical steam, and other gases known in the art.

In one embodiment the Dv0 of the composite material can range from 1 nm to 5 microns. In another embodiment the Dv0 of the composite ranges from 5 nm to 1 micron, for example 5-500 nm, for example 5-100 nm, for example 10-50 nm. In another embodiment the Dv0 of the composite ranges from 500 nm to 2 microns, or 750 nm to 1 um, or 1-2 um. microns to 2 microns. In other embodiments, the Dv0 of the composite ranges from 2-5 um, or >5 um.

In some embodiments the Dv50 of the composite material ranges from 5 nm to 20 um. In other embodiments the Dv50 of the composite ranges from 5 nm to 1 um, for example 5-500 nm, for example 5-100 nm, for example 10-50 nm. In another embodiment the Dv50 of the composite ranges from 500 nm to 2 um, 750 nm to 1 um, 1-2 um. In still another embodiments, the Dv50 of the composite ranges from 1 to 1000 um, for example from 1-100 um, for example from 1-10 um, for example 2-20 um, for example 3-15 um, for example 4-8 um. In certain embodiments, the Dv50 is >20 um, for example >50 um, for example >100 um.

The span (Dv50)/(Dv90−Dv10), wherein Dv10, Dv50 and Dv90 represent the particle size at 10%, 50%, and 90% of the volume distribution, can be varied from example from 100 to 10, from 10 to 5, from 5 to 2, from 2 to 1; in some embodiments the span can be less than 1. In certain embodiments, the composite comprising carbon and porous silicon material particle size distribution can be multimodal, for example, bimodal, or trimodal.

The surface functionality of the presently disclosed composite material exhibiting extremely durable intercalation of lithium may be altered to obtain the desired electrochemical properties. On such property for particulate composite materials is the concentration of atomic species at the surface of the composite material relative to the interior of the composite material. Such a difference in concentration in atomic species for the surface vs. interior of the particulate composite material can be determined as known in the art, for example by x-ray photoelectron spectroscopy (XPS).

Another property which can be predictive of surface functionality is the pH of the composite materials. The presently disclosed composite materials comprise pH values ranging from less than 1 to about 14, for example less than 5, from 5 to 8 or greater than 8. In some embodiments, the pH of the composite materials is less than 4, less than 3, less than 2 or even less than 1. In other embodiments, the pH of the composite materials is between about 5 and 6, between about 6 and 7, between about 7 and 8 or between 8 and 9 or between 9 and 10. In still other embodiments, the pH is high and the pH of the composite materials ranges is greater than 8, greater than 9, greater than 10, greater than 11, greater than 12, or even greater than 13.

The silicon-carbon composite material may comprise varying amounts of carbon, oxygen, hydrogen and nitrogen as measured by gas chromatography CHNO analysis. In one embodiment, the carbon content of the composite is greater than 98 wt. % or even greater than 99.9 wt % as measured by CHNO analysis. In another embodiment, the carbon content of the silicon-carbon composite ranges from about 10-90%, for example 20-80%, for example 30-70%, for example 40-60%.

In some embodiments, silicon-carbon composite material comprises a nitrogen content ranging from 0-90%, example 0.1-1%, for example 1-3%, for example 1-5%, for example 1-10%, for example 10-20%, for example 20-30%, for example 30-90%.

In some embodiments, the oxygen content ranges from 0-90%, example 0.1-1%, for example 1-3%, for example 1-5%, for example 1-10%, for example 10-20%, for example 20-30%, for example 30-90%.

The silicon-carbon composite material may also incorporate an electrochemical modifier selected to optimize the electrochemical performance of the non-modified composite. The electrochemical modifier may be incorporated within the pore structure and/or on the surface of the porous carbon scaffold, within the embedded silicon, or within the final layer of carbon, or conductive polymer, coating, or incorporated in any number of other ways. For example, in some embodiments, the composite materials comprise a coating of the electrochemical modifier (e.g., silicon or Al₂O₃) on the surface of the carbon materials. In some embodiments, the composite materials comprise greater than about 100 ppm of an electrochemical modifier. In certain embodiments, the electrochemical modifier is selected from iron, tin, silicon, nickel, aluminum and manganese.

In certain embodiments the electrochemical modifier comprises an element with the ability to lithiate from 3 to 0 V versus lithium metal (e.g. silicon, tin, sulfur). In other embodiments, the electrochemical modifier comprises metal oxides with the ability to lithiate from 3 to 0 V versus lithium metal (e.g. iron oxide, molybdenum oxide, titanium oxide). In still other embodiments, the electrochemical modifier comprises elements which do not lithiate from 3 to 0 V versus lithium metal (e.g. aluminum, manganese, nickel, metal-phosphates). In yet other embodiments, the electrochemical modifier comprises a non-metal element (e.g. fluorine, nitrogen, hydrogen). In still other embodiments, the electrochemical modifier comprises any of the foregoing electrochemical modifiers or any combination thereof (e.g. tin-silicon, nickel-titanium oxide).

The electrochemical modifier may be provided in any number of forms. For example, in some embodiments the electrochemical modifier comprises a salt. In other embodiments, the electrochemical modifier comprises one or more elements in elemental form, for example elemental iron, tin, silicon, nickel or manganese. In other embodiments, the electrochemical modifier comprises one or more elements in oxidized form, for example iron oxides, tin oxides, silicon oxides, nickel oxides, aluminum oxides or manganese oxides.

The electrochemical properties of the composite material can be modified, at least in part, by the amount of the electrochemical modifier in the material, wherein the electrochemical modifier is an alloying material such as silicon, tin, indium, aluminum, germanium, gallium. Accordingly, in some embodiments, the composite material comprises at least 0.10%, at least 0.25%, at least 0.50%, at least 1.0%, at least 5.0%, at least 10%, at least 25%, at least 50%, at least 75%, at least 90%, at least 95%, at least 99% or at least 99.5% of the electrochemical modifier.

The particle size of the composite material may expand upon lithiation as compared to the non-lithiated state. For example, the expansion factor, defined as ratio of the average particle size of particles of composite material comprising a porous silicon material upon lithiation divided by the average particle size under non-lithiated conditions. As described in the art, this expansion factor can be relatively large for previously known, non-optimal silicon-containing materials, for example about 4×(corresponding to a 400% volume expansion upon lithiation). The current inventors have discovered composite materials comprising a porous silicon material that can exhibit a lower extent of expansion, for example, the expansion factor can vary from 3.5 to 4, from 3.0 to 3.5, from 2.5 to 3.0, from 2.0 to 2.5, from 1.5 to 2.0, from 1.0 to 1.5.

It is envisioned that composite materials in certain embodiments will comprise a fraction of trapped pore volume, namely, void volume non-accessible to nitrogen gas as probed by nitrogen gas sorption measurement. Without being bound by theory, this trapped pore volume is important in that it provides volume into which silicon can expand upon lithiation.

In certain embodiments, the ratio of trapped void volume to the silicon volume comprising the composite particle is between 0.1:1 and 10:1. For example, the ratio of trapped void volume to the silicon volume comprising the composite particle is between 1:1 and 5:1, or 5:1 to 10:1. In embodiments, the ratio of ratio trapped void volume to the silicon volume comprising the composite particle is between 2:1 and 5:1, or about 3:1, in order to efficiently accommodate the maximum extent of expansion of silicon upon lithiation.

In certain embodiments, the electrochemical performance of the composite disclosed herein is tested in a half-cell; alternatively the performance of the composite with extremely durable intercalation of lithium disclosed herein is tested in a full cell, for example a full cell coin cell, a full cell pouch cell, a prismatic cell, or other battery configurations known in the art. The anode composition comprising the composite with extremely durable intercalation of lithium disclosed herein can further comprise various species, as known in the art. Additional formulation components include, but are not limited to, conductive additives, such as conductive carbons such as Super C45, Super P, Ketjenblack carbons, and the like, conductive polymers and the like, binders such as styrene-butadiene rubber sodium carboxymethylcellulose (SBR-Na-CMC), polyvinylidene difluoride (PVDF), polyimide (PI), polyacrylic acid (PAA) and the like, and combinations thereof. In certain embodiments, the binder can comprise a lithium ion as counter ion.

Other species comprising the electrode are known in the art. The % of active material in the electrode by weight can vary, for example between 1 and 5%, for example between 5 and 15%, for example between 15 and 25%, for example between and 35%, for example between 35 and 45%, for example between 45 and 55%, for example between 55 and 65%, for example between 65 and 75%, for example between 75 and 85%, for example between 85 and 95%. In some embodiments, the active material comprises between 80 and 95% of the electrode. In certain embodiment, the amount of conductive additive in the electrode can vary, for example between 1 and 5%, between 5 and 15%, for example between 15 and 25%, for example between 25 and 35%. In some embodiments, the amount of conductive additive in the electrode is between 5 and 25%. In certain embodiments, the amount of binder can vary, for example between 1 and 5%, between 5 and 15%, for example between 15 and 25%, for example between 25 and 35%. In certain embodiments, the amount of conductive additive in the electrode is between 5 and 25%.

The silicon-carbon composite material may be prelithiated, as known in the art. In certain embodiments, the prelithiation is achieved electrochemically, for example in a half cell, prior to assembling the lithiated anode comprising the porous silicon material into a full cell lithium ion battery. In certain embodiments, prelithiation is accomplished by doping the cathode with a lithium-containing compound, for example a lithium containing salt. Examples of suitable lithium salts in this context include, but are not limited to, dilithium tetrabromonickelate(II), dilithium tetrachlorocuprate(II), lithium azide, lithium benzoate, lithium bromide, lithium carbonate, lithium chloride, lithium cyclohexanebutyrate, lithium fluoride, lithium formate, lithium hexafluoroarsenate(V), lithium hexafluorophosphate, lithium hydroxide, lithium iodate, lithium iodide, lithium metaborate, lithium perchlorate, lithium phosphate, lithium sulfate, lithium tetraborate, lithium tetrachloroaluminate, lithium tetrafluoroborate, lithium thiocyanate, lithium trifluoromethanesulfonate, lithium trifluoromethanesulfonate, and combinations thereof.

The anode comprising the silicon-carbon composite material can be paired with various cathode materials to result in a full cell lithium ion battery. Examples of suitable cathode materials are known in the art. Examples of such cathode materials include, but are not limited to LiCoO₂ (LCO), LiNi_{0.8}Co_{0.15}Al_{0.05}O₂ (NCA), LiNi_{1/3}Co_{1/3}Mn_{1/3}O₂ (NMC), LiMn₂O₄ and variants (LMO), and LiFePO₄ (LFP).

For the full cell lithium ion battery comprising an anode further comprising the silicon-carbon composite material, pairing of cathode to anode can be varied. For example, the ratio of cathode-to-anode capacity can vary from 0.7 to 1.3. In certain embodiments, the ratio of cathode-to-anode capacity can vary from 0.7 to 1.0, for example from 0.8 to 1.0, for example from 0.85 to 1.0, for example from 0.9 to 1.0, for example from 0.95 to 1.0. In other embodiments, the ratio of cathode-to-anode capacity can vary from 1.0 to 1.3, for example from 1.0 to 1.2, for example from 1.0 to 1.15, for example from 1.0 to 1.1, for example from 1.0 to 1.05. In yet other embodiments, the ratio of cathode-to-anode capacity can vary from 0.8 to 1.2, for example from 0.9 to 1.1, for example from 0.95 to 1.05.

For the full cell lithium ion battery comprising an anode further comprising the silicon-carbon composite material, the voltage window for charging and discharging can be varied. In this regard, the voltage window can be varied as known in the art, depending on various properties of the lithium ion battery. For instance, the choice of cathode plays a role in the voltage window chosen, as known in the art. Examples of voltage windows vary, for example, in terms of potential versus Li/Li+, from 2.0 V to 5.0 V, for example from 2.5 V to 4.5V, for example from 2.5V to 4.2V.

For the full cell lithium ion battery comprising an anode further comprising the silicon-carbon composite material, the strategy for conditioning the cell can be varied as known in the art. For example, the conditioning can be accomplished by one or more charge and discharge cycles at various rate(s), for example at rates slower than the desired cycling rate. As known in the art, the conditioning process may also include a step to unseal the lithium ion battery, evacuate any gases generated within during the conditioning process, followed by resealing the lithium ion battery.

For the full cell lithium ion battery comprising an anode further comprising the silicon-carbon composite material, the cycling rate can be varied as known in the art, for example, the rate can between C/20 and 20C, for example between C10 to 10C, for example between C/5 and 5C. In certain embodiments, the cycling rate is C/10. In certain embodiments, the cycling rate is C/5. In certain embodiments, the cycling rate is C/2. In certain embodiments, the cycling rate is 1C. In certain embodiments, the cycling rate is 1C, with periodic reductions in the rate to a slower rate, for example cycling at 1C with a C/10 rate employed every 20^{th} cycle. In certain embodiments, the cycling rate is 2C. In certain embodiments, the cycling rate is 4C. In certain embodiments, the cycling rate is 5C. In certain embodiments, the cycling rate is 10C. In certain embodiments, the cycling rate is 20C.

The first cycle efficiency of the composite with extremely durable intercalation of lithium disclosed herein be determined by comparing the lithium inserted into the anode during the first cycle to the lithium extracted from the anode on the first cycle, prior prelithiation modification. When the insertion and extraction are equal, the efficiency is 100%. As known in the art, the anode material can be tested in a half-cell, where the counter electrode is lithium metal, the electrolyte is a 1M LiPF₆ 1:1 ethylene carbonate:diethylcarbonate (EC:DEC), using a commercial polypropylene separator. In certain embodiments, the electrolyte can comprise various additives known to provide improved performance, such as fluoroethylene carbonate (FEC) or other related fluorinated carbonate compounds, or ester co-solvents such as methyl butyrate, vinylene carbonate, and other electrolyte additives known to improve electrochemical performance of silicon-comprising anode materials.

Coulombic efficiency can be averaged, for example averaged over cycles 7 to cycle 25 when tested in a half cell. Coulombic efficiency can be averaged, for example averaged over cycles 7 to cycle 20 when tested in a half cell. In certain embodiments, the average efficiency of the composite with extremely durable intercalation of lithium is greater than 0.9, or 90%. In certain embodiments, the average efficiency is greater than 0.95, or 95%. In certain other embodiments, the average efficiency is 0.99 or greater, for example 0.991 or greater, for example 0.992 or greater, for example 0.993 or greater, for example 0.994 or greater, for example 0.995 or greater, for example 0.996 or greater, for example 0.997 or greater, for example 0.998 or greater, for example 0.999 or greater, for example 0.9991 or greater, for example 0.9992 or greater, for example 0.9993 or greater, for example 0.9994 or greater, for example 0.9995 or greater, for example 0.9996 or greater, for example 0.9997 or greater, for example 0.9998 or greater, for example 0.9999 or greater.

In still other embodiments the present disclosure provides a composite material exhibiting extremely durable intercalation of lithium, wherein when the composite material is incorporated into an electrode of a lithium-based energy storage device the composite material has a volumetric capacity at least 10% greater than when the lithium based energy storage device comprises a graphite electrode. In some embodiments, the lithium based energy storage device is a lithium ion battery. In other embodiments, the composite material has a volumetric capacity in a lithium-based energy storage device that is at least 5% greater, at least 10% greater, at least 15% greater than the volumetric capacity of the same electrical energy storage device having a graphite electrode. In still other embodiments, the composite material has a volumetric capacity in a lithium based energy storage device that is at least 20% greater, at least 30% greater, at least 40% greater, at least 50% greater, at least 200% greater, at least 100% greater, at least 150% greater, or at least 200% greater than the volumetric capacity of the same electrical energy storage device having a graphite electrode.

The composite material may be prelithiated, as known in the art. These lithium atoms may or may not be able to be separated from the carbon. The number of lithium atoms to 6 carbon atoms can be calculated by techniques known to those familiar with the art:

#Li=Q×3.6×MM/(C %×F)
wherein Q is the lithium extraction capacity measured in mAh/g between the voltages of 5 mV and 2.0V versus lithium metal, MM is 72 or the molecular mass of 6 carbons, F is Faraday's constant of 96500, C % is the mass percent carbon present in the structure as measured by CHNO or XPS.

The composite material can be characterized by the ratio of lithium atoms to carbon atoms (Li:C) which may vary between about 0:6 and 2:6. In some embodiments the Li:C ratio is between about 0.05:6 and about 1.9:6. In other embodiments the maximum Li:C ratio wherein the lithium is in ionic and not metallic form is 2.2:6. In certain other embodiments, the Li:C ratio ranges from about 1.2:6 to about 2:6, from about 1.3:6 to about 1.9:6, from about 1.4:6 to about 1.9:6, from about 1.6:6 to about 1.8:6 or from about 1.7:6 to about 1.8:6. In other embodiments, the Li:C ratio is greater than 1:6, greater than 1.2:6, greater than 1.4:6, greater than 1.6:6 or even greater than 1.8:6. In even other embodiments, the Li:C ratio is about 1.4:6, about 1.5:6, about 1.6:6, about 1.6:6, about 1.7:6, about 1.8:6 or about 2:6. In a specific embodiment the Li:C ratio is about 1.78:6.

In certain other embodiments, the composite material comprises an Li:C ratio ranging from about 1:6 to about 2.5:6, from about 1.4:6 to about 2.2:6 or from about 1.4:6 to about 2:6. In still other embodiments, the composite materials may not necessarily include lithium, but instead have a lithium uptake capacity (i.e., the capability to uptake a certain quantity of lithium, for example upon cycling the material between two voltage conditions (in the case of a lithium ion half cell, an exemplary voltage window lies between 0 and 3 V, for example between 0.005 and 2.7 V, for example between 0.005 and 1 V, for example between 0.005 and 0.8 V). While not wishing to be bound by theory, it is believed the lithium uptake capacity of the composite materials contributes to their superior performance in lithium based energy storage devices. The lithium uptake capacity is expressed as a ratio of the atoms of lithium taken up by the composite. In certain other embodiments, the composite material exhibiting extremely durable intercalation of lithium comprise a lithium uptake capacity ranging from about 1:6 to about 2.5:6, from about 1.4:6 to about 2.2:6 or from about 1.4:6 to about 2:6.

In certain other embodiments, the lithium uptake capacity ranges from about 1.2:6 to about 2:6, from about 1.3:6 to about 1.9:6, from about 1.4:6 to about 1.9:6, from about 1.6:6 to about 1.8:6 or from about 1.7:6 to about 1.8:6. In other embodiments, the lithium uptake capacity is greater than 1:6, greater than 1.2:6, greater than 1.4:6, greater than 1.6:6 or even greater than 1.8:6. In even other embodiments, the Li:C ratio is about 1.4:6, about 1.5:6, about 1.6:6, about 1.6:6, about 1.7:6, about 1.8:6 or about 2:6. In a specific embodiment the Li:C ratio is about 1.78:6.

### D. Enhancing the Graphitic Nature of the Porous Carbon Scaffold

In certain embodiments, the electrochemical properties of the silicon-carbon materials may be enhanced by enhancing the electrochemical properties of the carbon scaffold. In some embodiments, the graphitic nature of the carbon scaffold is enhanced, resulting in increased conductivity, such as increased ionic and/or electrical conductivity, and/or reduced reactivity, such as reduced reactivity when in contact with various other components present in LIBs such as electrolyte components, and/or other beneficial properties such as more stable SEI formed in LIBs.

The graphitic nature of the carbon scaffold may be enhanced by heat treating the porous carbon scaffold to partially transition the carbon structure from amorphous to graphitic. To this end, the temperature for heat treatment can be ≥900° C., for example ≥1000° C., ≥1100° C., ≥1200, ≥1300° C., ≥1400° C., ≥1500° C., ≥1600° C., ≥1700° C., ≥1800° C., ≥2000° C. or ≥3000° C. In some embodiment, the heat treatment temperature is 1000° C. to 3000° C., for example 1000° C. to 2700° C., for example 1000° C. to 2500° C., for example 1000° C. to 2300° C., for example 1000° C. to 2000° C., for example 1100° C. to 3000° C., for example 1100° C. to 2700° C., for example 1100° C. to 2500° C., for example 1100° C. to 2000° C., for example 1200° C. to 2000° C., for example 1100° C. to 1700° C.

In some embodiments, the pressure during the heat treatment can be below atmospheric pressure. In certain other embodiments, the pressure during the heat treatment can be above atmospheric pressure. In a preferred embodiment, the pressure during the heating of the porous carbon scaffold can be atmospheric pressure. The time of the heat treatment can vary, for example from 1 min to 24 h, and in some embodiments, the heat treatment can be carried out for greater than 24 h. In some embodiments, relative rapid heating, relatively short dwell time, and relatively rapid cooling are preferred in order to minimize the impact on total pore volume and pore volume distribution for the porous carbon as a result in the heat treatment. In some embodiments, the dwell time is 1 min to 1 h, or other embodiments, the dwell time is 1 h to 24 h, for example 1 to 2 h, 2 to 4 h, 4 to 8 h, or 8 h to 24 h.

In some embodiments, microwave energy can be employed to heat and/or otherwise enhance the graphitic nature of the carbon scaffold. Without being bound by theory, carbon particles are efficient microwave absorbers and a reactor can be envisioned wherein the particles are subjected to microwaves to heat them prior to introduction of the silicon-containing gas to be deposited to the particles.

Temperature is related to the average kinetic energy (energy of motion) of the atoms or molecules in a material, so agitating the molecules in this way increases the temperature of the material. Thus, dipole rotation is a mechanism by which energy in the form of electromagnetic radiation can raise the temperature of an object. Dipole rotation is the mechanism normally referred to as dielectric heating, and is most widely observable in the microwave oven where it operates most efficaciously on liquid water, and also, but much less so, on fats and sugars, and other carbon-comprising materials.

Dielectric heating involves the heating of electrically insulating materials by dielectric loss. A changing electric field across the material causes energy to be dissipated as the molecules attempt to line up with the continuously changing electric field. This changing electric field may be caused by an electromagnetic wave propagating in free space (as in a microwave oven), or it may be caused by a rapidly alternating electric field inside a capacitor. In the latter case, there is no freely propagating electromagnetic wave, and the changing electric field may be seen as analogous to the electric component of an antenna near field. In this case, although the heating is accomplished by changing the electric field inside the capacitive cavity at radio-frequency (RF) frequencies, no actual radio waves are either generated or absorbed. In this sense, the effect is the direct electrical analog of magnetic induction heating, which is also near-field effect (thus not involving radio waves).

At very high frequencies, the wavelength of the electromagnetic field becomes shorter than the distance between the metal walls of the heating cavity, or than the dimensions of the walls themselves. This is the case inside a microwave oven. In such cases, conventional far-field electromagnetic waves form (the cavity no longer acts as a pure capacitor, but rather as an antenna), and are absorbed to cause heating, but the dipole-rotation mechanism of heat deposition remains the same. However, microwaves are not efficient at causing the heating effects of low frequency fields that depend on slower molecular motion, such as those caused by ion-drag.

Microwave heating is a sub-category of dielectric heating at frequencies above 100 MHz, where an electromagnetic wave can be launched from a small dimension emitter and guided through space to the target. Modern microwave ovens make use of electromagnetic waves with electric fields of much higher frequency and shorter wavelength than RF heaters. Typical domestic microwave ovens operate at 2.45 GHz, but 915 MHz ovens also exist. This means that the wavelengths employed in microwave heating are 12 or 33 cm (4.7 or 13.0 in). This provides for highly efficient, but less penetrative, dielectric heating. Although a capacitor-like set of plates can be used at microwave frequencies, they are not necessary, since the microwaves are already present as far field type electromagnetic radiation, and their absorption does not require the same proximity to a small antenna, as does RF heating. The material to be heated (a non-metal) can therefore simply be placed in the path of the waves, and heating takes place in a non-contact process.

Microwave absorbing materials are thus capable of dissipating an electromagnetic wave by converting it into thermal energy. Without being bound by theory, a material's microwave absorption capacity is mainly determined by its relative permittivity, relative permeability, the electromagnetic impedance match, and the material microstructure, for example its porosity and/or nano- or micro-structure. When a beam of microwave irradiates the surface of a microwave absorbing material, a suitable matching condition for the electromagnetic impedance can enable almost zero reflectivity of the incident microwave, ultimately resulting in transfer of thermal energy to the absorbing material.

Carbon materials are capable of absorbing microwaves, i.e., they are easily heated by microwave radiation, i.e. infrared radiation and radio waves in the region of the electromagnetic spectrum. More specifically, they are defined as those waves with wavelengths between 0.001 and 1 m, which correspond to frequencies between 300 and 0.3 GHz. The ability of carbon to be heated in the presence of a microwave field, is defined by its dielectric loss tangent: tan δ=ε″/ε′. The dielectric loss tangent is composed of two parameters, the dielectric constant (or real permittivity), c′, and the dielectric loss factor (or imaginary permittivity), ε″; i.e., ε=ε′−i ε″, where ε is the complex permittivity. The dielectric constant (ε′) determines how much of the incident energy is reflected and how much is absorbed, while the dielectric loss factor (ε″) measures the dissipation of electric energy in form of heat within the material. For optimum microwave energy coupling, a moderate value of ε′ should be combined with high values of ε″ (and so high values of tan δ), to convert microwave energy into thermal energy. Thus, while some materials do not possess a sufficiently high loss factor to allow dielectric heating (transparent to microwaves), other materials, e.g. some inorganic oxides and most carbon materials, are excellent microwave absorbers. On the other hand, electrical conductor materials reflect microwaves. For example, graphite and highly graphitized carbons may reflect a considerable fraction of microwave radiation. In the case of carbons, where delocalized π-electrons are free to move in relatively broad regions, an additional and very interesting phenomenon may take place. The kinetic energy of some electrons may increase enabling them to jump out of the material, resulting in the ionization of the surrounding atmosphere. At a macroscopic level, this phenomenon is perceived as sparks or electric arcs formation. But, at a microscopic level, these hot spots are actually plasmas. Most of the time these plasmas can be regarded as microplasmas both from the point of view of space and time, since they are confined to a tiny region of the space and last for just a fraction of a second. An intensive generation of such microplasmas may have important implications for the processes involved.

Without being bound by theory, heating of carbon materials by microwave heating offers a number of advantages over conventional heating such as: (i) non-contact heating; (ii) energy transfer instead of heat transfer; (iii) rapid heating; (iv) selective material heating; (v) volumetric heating; (vi) quick start-up and stopping; (vii) heating from the interior of the material body; and, (viii) higher level of safety and automation. The high capacity of carbon materials to absorb microwave energy and convert it into heat is illustrated in Table 3 (provided from the reference J. A. Menendez, A. Arenillas, B. Fidalgo, Y. Fernandez, L. Zubizarreta, E. G. Calvo, J. M. Bermudez, “Microwave heating processes involving carbon materials”, Fuel Processing Technology, 2010, 91 (1), 1-8), where the dielectric loss tangents of examples of different carbons are listed. As can be seen, the loss tangents of most of the carbons, except for coal, are higher than the loss tangent of distilled water (tan δ of distilled water=0.118 at 2.45 GHz and room temperature).

TABLE 3
Examples of dielectric loss tangents for different carbon materials
at a frequency of 2.45 GHz and room temperature.

| Carbon Type | tanδ = ε″/ε′ |
|---|---|
| Coal | 0.02-0.08 |
| Carbon foam | 0.05-0.20 |
| Charcoal | 0.11-0.29 |
| Carbon black | 0.35-0.83 |
| Activated carbon | 0.22-2.95 |
| Carbon nanotubes | 0.25-1.14 |

Whether via conventional heat treatment or microwave treatment, an important consideration for enhancing the graphitic nature of the porous carbon scaffold is the impact on total pore volume and pore volume distribution. To this end, the total pore volume and pore volume distribution for the porous carbon scaffold can be determined by gas sorption analysis, for example nitrogen and/or carbon dioxide gas sorption analysis, as known in the art. In this fashion, the pore volume and pore volume distribution can be determined before and after the treatment to enhance graphitization. In some embodiments, after treatment the surface area of the porous carbon scaffold decreases by at least 30 m2/g, for example at least 50 m2/g, for example at least 100 m2/g, for example at least 200 m2/g, for example at least 300 m2/g, for example at least 500 m2/g. In some embodiments, after treatment the pore volume of the porous carbon scaffold decreases by at least 0.01 cm3/g, for example at least 0.05 cm3/g, for example at least 0.1 cm3/g, for example at least 0.2 cm3/g, for example at least 0.3 cm3/g, for example at least 0.5 cm3/g.

In some embodiments, after the treatment the surface area of the porous carbon scaffold increases by at least 30 m2/g, for example at least 50 m2/g, for example at least 100 m2/g, for example at least 200 m2/g, for example at least 300 m2/g, for example at least 500 m2/g. In some embodiments, after the treatment the pore volume of the porous carbon scaffold increases by at least 0.01 cm3/g, for example at least 0.05 cm3/g, for example at least 0.1 cm3/g, for example at least 0.2 cm3/g, for example at least 0.3 cm3/g, for example at least 0.5 cm3/g. In certain embodiments wherein surface area of the porous carbon scaffold increases after treatment, and/or the pore volume of the porous carbon scaffold increases after treatment, the porous carbon scaffold comprises an electrochemical modifier that acts as a graphitization catalyst, such Al, Cr, Mn, Fe, Co, Ni, Ca, Ti, V, Mo or W, or combinations thereof.

Without being bound by theory, graphitization of the porous carbon scaffold comprising the graphitization catalyst occurs at much more mild conditions, for example shorter time and/or lower temperature conditions, compared to graphitization of the porous carbon scaffold in the absence of graphitization catalyst. The graphitization catalyst can be incorporated into the process for preparing the silicon-carbon composite at various steps. For example, the graphitization catalyst can be added to the solid precursor materials prior to pyrolysis and subsequent activation to yield the porous carbon scaffold comprising graphitization catalyst. In one embodiment, the graphitization catalyst can be added to the solid precursor materials prior to combined pyrolysis and activation to yield the porous carbon scaffold comprising graphitization catalyst. In another embodiment, the graphitization catalyst can be added to pyrolyzed porous carbon material prior to activation to yield the porous carbon scaffold comprising graphitization catalyst. In another embodiment, the graphitization catalyst can be added to the activated porous carbon material to yield the porous carbon scaffold comprising graphitization catalyst.

The graphitization can be accomplished at varying steps in the process for preparing the silicon-carbon composite. For example, the pyrolyzed porous carbon material can be graphitized prior to activation and subsequent CVI processing to yield the silicon-carbon composite material. In one embodiment, the activated porous carbon material can be graphitized prior to CVI processing to yield the silicon-carbon composite material.

Comminution can be carried out to reduce the particle size at various steps in the process for preparing the silicon-carbon composite particles. For example, the pyrolyzed porous carbon material can be comminuted prior to graphitization and subsequent activation and CVI processing to yield the silicon-carbon composite particles. In another embodiment, the pyrolyzed and graphitized porous carbon material can be communited prior to activation and subsequent CVI processing to yield the silicon-carbon composite particles. In another embodiment, the activated porous carbon material can be communited prior to graphitization and subsequent CVI processing to yield the silicon-carbon composite particles. In another embodiment, the activated and graphitized porous carbon material can be communited prior to CVI processing to yield the silicon-carbon composite particles.

For the above embodiment, the extent of graphitic nature of the carbon may differ between the carbon particle surface and the surface of pores within the carbon particle. In some embodiments, the extent of graphitic nature of the carbon is greater at the carbon particle surface compared to the surface of pores within the carbon particle. Without being bound by theory, such embodiment allows for electrical and/or ionic conductivity enhancement at the particle surface that, in turn, provides electrochemical benefits when the silicon-carbon composite particles are employed as anode for lithiym batteries, such as increased rate capability and faster charging and/or discharging, more stable SEI, lower reactivity of the carbon surface leading to increased high temperature stability and/or calendar life.

In some embodiments, the extent of graphitic nature of the carbon is greater at the surface of pores within the carbon particle compared to the the carbon particle surface. Without being bound by theory, such embodiment allows for electrical and/or ionic conductivity enhancement at the surface or pores that, in turn, provides electrochemical benefits when the silicon-carbon composite particles are employed as anode for lithiym batteries, such as increased rate capability and faster charging and/or discharging.

In some embodiments, the silicon-carbon composite materials comprise a particle size distribution, and the extent of graphitic nature of the carbon particle varies with the varying particle size of the carbon particle. For this characterization, the silicon-composite particles can be size fractionated (as known in the art) to yield two or more fractions of material, wherein the Dv50 for the fractions differ. For example, the silicon-composite particles can fractionated into one fraction comprising Dv50<1 um and another fraction comprising Dv50>1 um, the difference in graphitic extent of the two fractions can be compared, for example by I_{D}/I_{G} as measured by Raman spectroscopy. Accordingly, the difference in graphitic extent of the two fractions can be expressed as:

ΔI_{D}/I_{G}=([I_{D}/I_{G}]Dv,50>1−[I_{D}/I_{G}]Dv,50<1)

wherein [I_{D}/I_{G}]Dv,50>1 is the I_{D}/I_{G} for the fraction of particles comprising Dv50>1 and [I_{D}/I_{G}]Dv,50<1 is the I_{D}/I_{G} for the fraction of particles comprising Dv50<1. Accordingly, ΔI_{D}/I_{G} can vary between 0 and 2, for example between 0 and 1, for example between 0.01 and 0.8, for example between 0.01 and 0.7, for example between 0.01 and 0.6, for example between 0.01 and 0.5, for example between 0.01 and 0.4, for example between 0.01 and 0.3, for example between 0.01 and 0.2, for example between 0.01 and 0.1, 0.1 and 0.8, for example between 0.1 and 0.7, for example between 0.1 and 0.6, for example between 0.1 and 0.5, for example between 0.1 and 0.4, for example between 0.1 and 0.3, for example between 0.1 and 0.2, for example between 0.1 and 0.7, for example between 0.2 and 0.6, for example between 0.3 and 0.5.

In some embodiments, the electrochemical properties of the porous carbon scaffold, and/or the silicon-carbon composite, can be enhanced by addition of conductive carbon additive particles including, but not limited to, graphite particles, Super C45 particles, Super P particles, carbon black particles, nanoscale carbon particles such as carbon nanotubes or other carbon nanostructures, or combinations thereof. In such embodiments, the addition of conductive carbon additive facilitates improved electrical conductivity, packing density, and/or electrochemical efficiency for the doped porous carbon scaffold and/or silicon-carbon composite produced therefrom.

To this end, the addition of conductive carbon additives particles can occur at various steps in the preparation of the silicon-carbon composite. In one embodiment, the conductive carbon additive particles are added to the carbon precursors used to produce the porous carbon scaffold, and subsequent pyrolysis, and activation and graphitization of the porous carbon scaffold, and subsequent CVI processing to produce the silicon-carbon composite. In another embodiment, the conductive carbon additive particles are added to the carbon precursors used to produce the porous carbon scaffold, and subsequent pyrolysis, graphitization, and activation of the porous carbon scaffold, and subsequent CVI processing to produce the silicon-carbon composite. In another embodiment, the conductive carbon additive particles are added to the carbon precursors used to produce the porous carbon scaffold, and subsequent pyrolysis, activation, and graphitization of the porous carbon scaffold, and subsequent CVI processing to produce the silicon-carbon composite.

In such embodiments, the addition of conductive carbon additive serves as a graphitization catalyst for graphitizing the porous carbon scaffold. In other embodiments, the addition of conductive carbon additive serves as a graphitization seed particle for graphitizing the porous carbon scaffold. In other embodiments, the addition of conductive carbon additive facilitates improved electrical conductivity, packing density, and/or electrochemical efficiency for the doped porous carbon scaffold and/or silicon-carbon composite produced therefrom.

In yet other embodiments, the electrochemical properties of the porous carbon scaffold, and/or the silicon-carbon composite, can be enhanced by addition of conductive carbon additive particles to the pyrolyzed porous carbon scaffold prior to graphitization and subsequent activation, and subsequent CVI processing to prepare the silicon-carbon composite. In yet other embodiments, the electrochemical properties of the porous carbon scaffold, and/or the silicon-carbon composite, can be enhanced by addition of conductive carbon additive particles to the activated porous carbon scaffold prior to graphitization and subsequent activation, and subsequent CVI processing to prepare the silicon-carbon composite.

The presence of conductive carbon additive as a fraction of the total mass of porous carbon can vary, for example, the conductive carbon additives can comprise 0.1% to 90% of the total mass of porous carbon scaffold, for example 1% to 50%, for example 1% to 40%, for example for example 1% to 30%, for example 1% to 20%, for example 1% to 10%, for example 1% to 5%, for example 5% to 10%, for example 10% to 20%, for example 20% to 30%, for example 30% to 40%, for example 40% to 50%.

### EXAMPLES

### Example 1. Production of Silicon-Carbon Composite Material by CVI

The properties of the carbon scaffold (Carbon Scaffold 1) employed for producing the silicon-carbon composite is presented in Table 3. Employing Carbon Scaffold 1, the silicon-carbon composite (Silicon-Carbon Composite 1) was produced by CVI as follows. A mass of 0.2 grams of amorphous porous carbon was placed into a 2 in.×2 in. ceramic crucible then positioned in the center of a horizontal tube furnace. The furnace was sealed and continuously purged with nitrogen gas at 500 cubic centimeters per minute (ccm). The furnace temperature was increased at 20° C./min to 450° C. peak temperature where it was allowed to equilibrate for 30 minutes. At this point, the nitrogen gas is shutoff and then silane and hydrogen gas are introduced at flow rates of 50 ccm and 450 ccm, respectively for a total dwell time of 30 minutes. After the dwell period, silane and hydrogen were shutoff and nitrogen was again introduced to the furnace to purge the internal atmosphere. Simultaneously the furnace heat is shutoff and allowed to cool to ambient temperature. The completed Si—C material is subsequently removed from the furnace.

TABLE 3
Description of carbon scaffold employed for Example 1.

| Carbon | Surface | Pore | % | % | % |
|---|---|---|---|---|---|
| Scaffold | Area | Volume | Micro- | Meso- | Macro- |
| # | (m2/g) | (cm3/g) | pores | pores | pores |
| 1 | 1710 | 0.762 | 93.1 | 6.8 | 0.1 |

### Example 2. Analysis of Various Silicon-Composite Materials

A variety of carbon scaffold materials were employed, and the carbon scaffold materials were characterized by nitrogen sorption gas analysis to determine specific surface area, total pore volume, and fraction of pore volume comprising micropores, mesopores, and macropores. The characterization data for the carbon scaffold materials is presented in Table 4, namely the data for carbon scaffold surface area, pore volume, and pore volume distribution (% micropores, % mesopores, and % macropores), all as determined by nitrogen sorption analysis.

TABLE 4
Properites of various carbon scaffold materials.

| Carbon | Surface | Pore | % | % | % |
|---|---|---|---|---|---|
| Scaffold | Area | Volume | Micro- | Meso- | Macro- |
| # | (m2/g) | (cm3/g) | pores | pores | pores |
| 1 | 1710 | 0.762 | 93.1 | 6.8 | 0.1 |
| 2 | 1744 | 0.72 | 97.2 | 2.7 | 0.1 |
| 3 | 1581 | 0.832 | 69.1 | 30.9 | 0.1 |
| 4 | 1710 | 0.817 | 80.1 | 19.9 | 0 |
| 5 | 1835 | 0.9 | 82.2 | 17.8 | 0 |
| 6 | 1475 | 1.06 | 52.4 | 47.6 | 0 |
| 7 | 453 | 0.5 | 3.9 | 91.1 | 5.1 |
| 8 | 787 | 2.284 | 0 | 59.1 | 40.9 |
| 9 | 1713 | 0.76 | 91 | 9 | 0 |

The carbons scaffold sample as described in Table 4 were employed to produce a variety of silicon-carbon composite materials employing the CVI methodology in a static bed configuration as generally described in Example 1. These silicon-carbon samples were produced employing a range of process conditions: silane concentration 1.25% to 100%, diluent gas nitrogen or hydrogen, carbon scaffold starting mass 0.2 g to 700 g.

The surface area for the silicon-carbon composites was determined. The silicon-carbon composites were also analyzed by TGA to determine silicon content and the Z. Silicon-carbon composite materials were also tested in half-cell coin cells. The anode for the half-cell coin cell can comprise 60-90% silicon-carbon composite, 5-20% Na-CMC (as binder) and 5-20% Super C45 (as conductivity enhancer), and the electrolyte can comprise 2:1 ethylene carbonate:diethylene carbonate, 1 M LiPF6 and 10% fluoroethylene carbonate. The half-cell coin cells can be cycled at 25° C. at a rate of C/5 for 5 cycles and then cycled thereafter at C/10 rate. The voltage can be cycled between 0 V and 0.8 V, alternatively, the voltage can be cycled between 0 V and 1.5 V. From the half-cell coin cell data, the maximum capacity can be measured, as well as the average Coulombic efficiency (CE) over the range of cycles from cycle 7 to cycle 20. Physicochemical and electrochemical properties for various silicon-carbon composite materials are presented in Table 5.

TABLE 5
Properites of various silicon-carbon materials.

| Silicon- | | | | | | |
|---|---|---|---|---|---|---|
| Carbon | Carbon | Surface | Si | | Max | Average |
| Composite | Scaffold | Area | content | | Capacity | CE |
| # | # | (m2/g) | (%) | Z | (mAh/g) | (7-20) |
| 1 | 1 | 7 | 45.0 | 0.2 | 1433 | 0.9981 |
| 2 | 1 | 7 | 45.4 | 0.6 | 1545 | 0.9980 |
| 3 | 1 | 6 | 45.8 | 0.6 | 1510 | 0.9975 |
| 4 | 2 | 3.06 | 50.1 | 1.0 | 1665 | 0.9969 |
| 5 | 2 | 1.96 | 51.3 | 2.0 | 1662 | 0.9974 |
| 6 | 3 | 140 | 43.1 | 3.2 | 832 | 0.9941 |
| 7 | 2 | 1.61 | 48.7 | 2.8 | 1574 | 0.9977 |
| 8 | 2 | 2 | 48.5 | 3.0 | 1543 | 0.9972 |
| 9 | 1 | 8 | 46.3 | 0.2 | 1373 | 0.9976 |
| 10 | 4 | 44 | 51.2 | 6.2 | 1614 | 0.9975 |
| 11 | 5 | 94 | 48.9 | 6.2 | 1455 | 0.9969 |
| 12 | 6 | 61 | 52.1 | 10.6 | 2011 | 0.9869 |
| 13 | 7 | 68.5 | 34.6 | 17.2 | 1006 | 0.9909 |
| 14 | 8 | 20 | 74 | 33.5 | 2463 | 0.9717 |
| 15 | 8 | 149 | 57.7 | 34.5 | 1892 | 0.9766 |
| 16 | 8 | 61.7 | 68.9 | 38.7 | 2213 | 0.9757 |
| 17 | 9 | 11 | 46.1 | 0.8 | 1675 | 0.9990 |
| 18 | 9 | 11 | 46.7 | 2.0 | 1739 | 0.9985 |
| 19 | 9 | 15.1 | 46.8 | 1.7 | 1503 | 0.9980 |
| 20 | 9 | 4.1 | 47.9 | 4.2 | 1790 | 0.9953 |
| 21 | 9 | 5 | 48.1 | 4.6 | 1861 | 0.9962 |

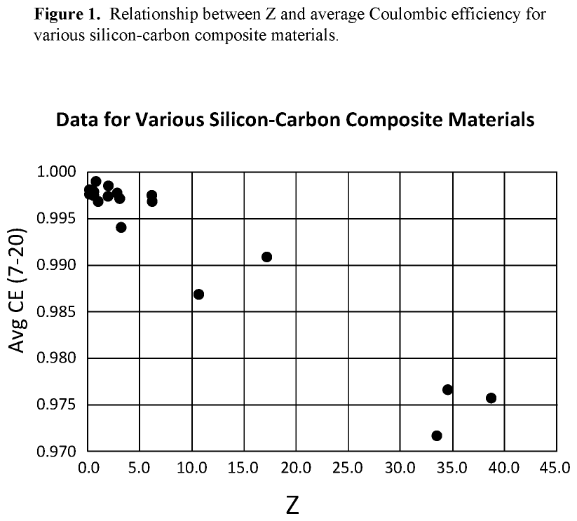

A plot of the average Coulombic efficiency as a function of the Z is presented in FIG. 1. As can seen there was dramatic increase in the average Coulombic efficiency for silicon-carbon samples with low Z. In particular, all silicon-carbon samples with Z below 10.0 exhibited average Coulombic efficiency ≥0.9941, and all silicon-carbon samples with Z above 10 (Silicon-Carbon Composite Sample 12 through Silicon-Carbon Composite Sample 16) were observed to have average Coulombic efficiency ≤0.9909. Without being bound by theory, higher Coulombic efficiency for the silicon-carbon samples with Z<10 provides for superior cycling stability in full cell lithium ion batteries. Further inspection of Table reveals the surprising and unexpected finding that the combination of silicon-carbon composite samples with Z<10 and also comprising carbon scaffold comprising >69.1 microporosity provides for average Coulombic efficiency ≥0.9969.

Therefore, in a preferred embodiment, the silicon-carbon composite material comprises a Z less than 10, for example less Z less than 5, for example less Z less than 3, for example less Z less than 2, for example less Z less than 1, for example less Z less than 0.5, for example less Z less than 0.1, or Z of zero.

In certain preferred embodiments, the silicon-carbon composite material comprises a Z less than 10 and a carbon scaffold with >70% microporosity, for example Z less than 10 and >80% microporosity, for example Z less than 10 and >90% microporosity, for example Z less than 10 and >95% microporosity, for example Z less than 5 and >70% microporosity, for example Z less than 5 and >80% microporosity, for example Z less than 5 and >90% microporosity, for example Z less than 5 and >95% microporosity, for example Z less than 3 and >70% microporosity, for example Z less than 3 and >80% microporosity, for example Z less than 3 and >90% microporosity, for example Z less than 3 and >95% microporosity, for example Z less than 2 and >70% microporosity, for example Z less than 2 and >80% microporosity, for example Z less than 2 and >90% microporosity, for example Z less than 2 and >95% microporosity, for example Z less than 1 and >70% microporosity, for example Z less than 1 and >80% microporosity, for example Z less than 1 and >90% microporosity, for example Z less than 1 and >95% microporosity, for example Z less than 0.5 and >70% microporosity, for example Z less than 0.5 and >80% microporosity, for example Z less than 0.5 and >90% microporosity, for example Z less than 0.5 and >95% microporosity, for example Z less than 0.1 and >70% microporosity, for example Z less than 0.1 and >80% microporosity, for example Z less than 0.1 and >90% microporosity, for example Z less than 0.1 and >95% microporosity, for example Z of zero and >70% microporosity, for example Z of zero and >80% microporosity, for example Z of zero and >90% microporosity, for example Z of zero and >95% microporosity.

In certain preferred embodiments, the silicon-carbon composite material comprises a Z less than 10 and a carbon scaffold with >70% microporosity, and wherein the silicon-carbon composite also comprises 15%-85% silicon, and surface area less than 100 m2/g, for example Z less than 10 and >70% microporosity, and wherein the silicon-carbon composite also comprises 15%-85% silicon, and surface area less than 50 m2/g, for example Z less than 10 and >70% microporosity, and wherein the silicon-carbon composite also comprises 15%-85% silicon, and surface area less than 30 m2/g, for example Z less than 10 and >70% microporosity, and wherein the silicon-carbon composite also comprises 15%-85% silicon, and surface area less than 10 m2/g, for example Z less than 10 and >70% microporosity, and wherein the silicon-carbon composite also comprises 15%-85% silicon, and surface area less than 5 m2/g, for example Z less than 10 and >80% microporosity, and wherein the silicon-carbon composite also comprises 15%-85% silicon, and surface area less than 50 m2/g, for example Z less than 10 and >80% microporosity, and wherein the silicon-carbon composite also comprises 15%-85% silicon, and surface area less than m2/g, for example Z less than 10 and >80% microporosity, and wherein the silicon-carbon composite also comprises 15%-85% silicon, and surface area less than 10 m2/g, for example Z less than 10 and >80% microporosity, and wherein the silicon-carbon composite also comprises 15%-85% silicon, and surface area less than 5 m2/g, for example Z less than 10 and >90% microporosity, and wherein the silicon-carbon composite also comprises 15%-85% silicon, and surface area less than 50 m2/g, for example Z less than 10 and >90% microporosity, and wherein the silicon-carbon composite also comprises 15%-85% silicon, and surface area less than 30 m2/g, for example Z less than 10 and >90% microporosity, and wherein the silicon-carbon composite also comprises 15%-85% silicon, and surface area less than 10 m2/g, for example Z less than 10 and >90% microporosity, and wherein the silicon-carbon composite also comprises 15%-85% silicon, and surface area less than 5 m2/g, for example Z less than 10 and >95% microporosity, and wherein the silicon-carbon composite also comprises 15%-85% silicon, and surface area less than 50 m2/g, for example Z less than 10 and >95% microporosity, and wherein the silicon-carbon composite also comprises 15%-85% silicon, and surface area less than 30 m2/g, for example Z less than 10 and >95% microporosity, and wherein the silicon-carbon composite also comprises 15%-85% silicon, and surface area less than 10 m2/g, for example Z less than 10 and >95% microporosity, and wherein the silicon-carbon composite also comprises 15%-85% silicon, and surface area less than 5 m2/g.

In certain preferred embodiments, the silicon-carbon composite material comprises a Z less than 10 and a carbon scaffold with >70% microporosity, and wherein the silicon-carbon composite also comprises 30%-60% silicon, and surface area less than 100 m2/g, for example Z less than 10 and >70% microporosity, and wherein the silicon-carbon composite also comprises 30%-60% silicon, and surface area less than 50 m2/g, for example Z less than 10 and >70% microporosity, and wherein the silicon-carbon composite also comprises 30%-60% silicon, and surface area less than 30 m2/g, for example Z less than 10 and >70% microporosity, and wherein the silicon-carbon composite also comprises 30%-60% silicon, and surface area less than 10 m2/g, for example Z less than 10 and >70% microporosity, and wherein the silicon-carbon composite also comprises 30%-60% silicon, and surface area less than 5 m2/g, for example Z less than 10 and >80% microporosity, and wherein the silicon-carbon composite also comprises 30%-60% silicon, and surface area less than 50 m2/g, for example Z less than 10 and >80% microporosity, and wherein the silicon-carbon composite also comprises 30%-60% silicon, and surface area less than m2/g, for example Z less than 10 and >80% microporosity, and wherein the silicon-carbon composite also comprises 30%-60% silicon, and surface area less than 10 m2/g, for example Z less than 10 and >80% microporosity, and wherein the silicon-carbon composite also comprises 30%-60% silicon, and surface area less than 5 m2/g, for example Z less than 10 and >90% microporosity, and wherein the silicon-carbon composite also comprises 30%-60% silicon, and surface area less than 50 m2/g, for example Z less than 10 and >90% microporosity, and wherein the silicon-carbon composite also comprises 30%-60% silicon, and surface area less than 30 m2/g, for example Z less than 10 and >90% microporosity, and wherein the silicon-carbon composite also comprises 30%-60% silicon, and surface area less than 10 m2/g, for example Z less than 10 and >90% microporosity, and wherein the silicon-carbon composite also comprises 30%-60% silicon, and surface area less than 5 m2/g, for example Z less than 10 and >95% microporosity, and wherein the silicon-carbon composite also comprises 30%-60% silicon, and surface area less than 50 m2/g, for example Z less than 10 and >95% microporosity, and wherein the silicon-carbon composite also comprises 30%-60% silicon, and surface area less than 30 m2/g, for example Z less than 10 and >95% microporosity, and wherein the silicon-carbon composite also comprises 30%-60% silicon, and surface area less than 10 m2/g, for example Z less than 10 and >95% microporosity, and wherein the silicon-carbon composite also comprises 30%-60% silicon, and surface area less than 5 m2/g.

### Example 3. dV/dQ for Various Silicon-Composite Materials

Differential capacity curve (dQ/dV vs Voltage) is often used as a non-destructive tool to understand the phase transition as a function of voltage in lithium battery electrodes (M. N. Obrovac et al. Structural Changes in Silicon Anodes during Lithium Insertion/Extraction, Electrochemical and Solid-State Letters, 7 (5) A93-A96 (2004); Ogata, K. et al. Revealing lithium-silicide phase transformations in nano-structured silicon-based lithium ion batteries via in situ NMR spectroscopy. Nat. Commun. 5:3217). Differential capacity plots presented here is calculated from the data obtained using galvanostatic cycling at 0.1C rate between 5 mV to 0.8V in a half-cell coin cell at 25° C. Typical differential capacity curve for a silicon-based material in a half-cell vs lithium can be found in many literature references (Loveridge, M. J. et al. Towards High Capacity Li-Ion Batteries Based on Silicon-Graphene Composite Anodes and Sub-micron V-doped LiFePO4 Cathodes. Sci. Rep. 6, 37787; doi: 10.1038/srep37787 (2016); M. N. Obrovac et al. Li15Si4Formation in Silicon Thin Film Negative Electrodes, Journal of The Electrochemical Society, 163 (2) A255-A261 (2016); Q. Pan et al. Improved electrochemical performance of micro-sized SiO-based composite anode by prelithiation of stabilized lithium metal powder, Journal of Power Sources 347 (2017) 170-177). First cycle lithiation behavior is dependent on the crystallinity of the silicon and oxygen content among other factors.

After first cycle, previous amorphous silicon materials in the art exhibit two specific phase transition peaks in the dQ/dV vs V plot for lithiation, and correspondingly two specific phase transition peaks in the dQ/dV vs V plot for delithiation. For lithiation, one peak corresponding to lithium-poor Li—Si alloy phase occurs between 0.2-0.4 V and another peak corresponding to a lithium-rich Li—Si alloy phase occurs below 0.15 V. For delithiation, one delithiation peak corresponding to the extraction of lithium occurs below 0.4 V and another peak occurs between 0.4 V and 0.55 V. If the Li15Si4 phase is formed during lithiation, it is delithiated at −0.45V and appears as a very narrow sharp peak.

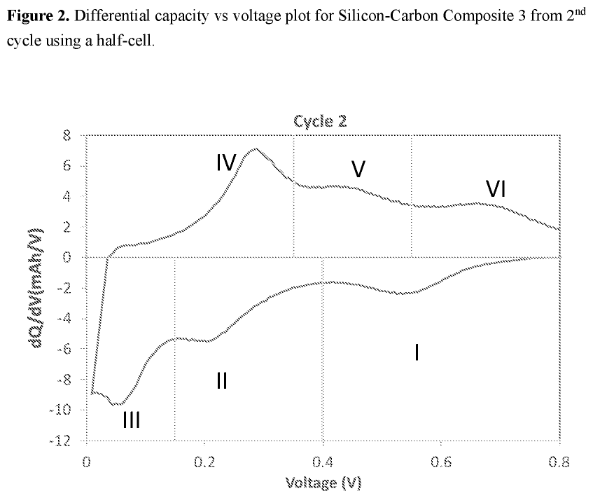

FIG. 2 depicts the dQ/dV vs Voltage curve for cycle 2 for the silicon-carbon composite material corresponding to Silicon-Carbon Composite 3 from Example 1. Silicon-Carbon Composite 3 comprises a Z of 0.6. For ease of identification, the plot is divided into regimes I, II, II, IV, V, and VI. Regimes I (0.8 V to 0.4 V), II (0.4 V to 0.15 V), III (0.15 V to 0 V) comprise the lithiation potentials and Regimes IV (0 V to 0.4 V), V (0.4 V to 0.55 V), VI (0.55 V to 0.8 V) comprise the delithiation potential. As described above, previous amorphous silicon-based materials in the art exhibit phase-transition peaks for two regimes (Regime II and Regime III) in the lithiation potential and two regimes (Regime IV and Regime V) in the dethiation potentials.

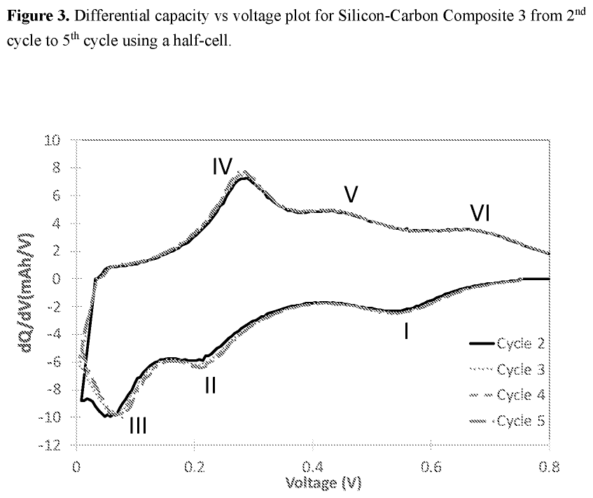

As can be seen in FIG. 2, the dQ/dV vs Voltage curve reveals surprising and unexpected result that Silicon-Carbon Composite 3, which comprises a Z of 0.6, comprises two additional peaks in the dQ/dV vs Voltage curve, namely Regime I in the lithiation potential and Regime VI in the delithiation potential. All 6 peaks are are reversible and observed in the subsequent cycles as well, as shown in FIG. 3.

Without being bound by theory, such trimodal behavior for the dQ/dV vs V curve is novel, and likewise reflects a novel form of silicon.

Notably, the novel peaks observed in Regime I and Regime VI are more pronounced in certain scaffold matrixes and completely absent in others samples illustrating the prior art (silicon-carbon composite samples with Z>10, see explanation and table below).

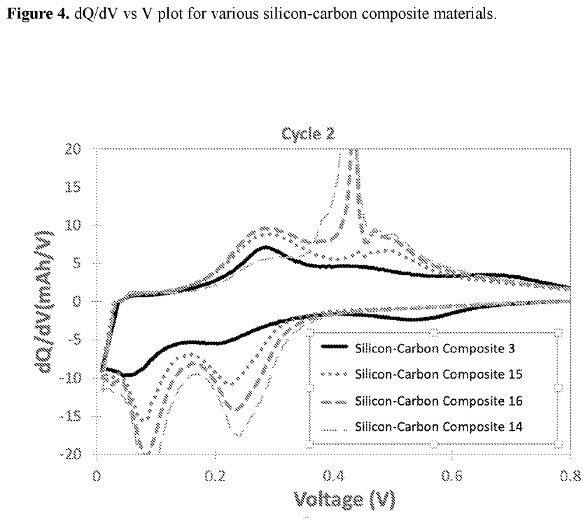

FIG. 4 presents the dQ/dV vs V curve for Silicon-Carbon Composite 3, wherein the novel peaks in Regime I and Regime VI are evident, in comparison to Silicon-Carbon Composite 15, Silicon-Carbon Composite 16, and Silicon-Carbon Composite 14, all three of which comprise Z>10 and whose dQ/dV vs V curves are devoid of the any peaks in Regime I and Regime VI.

Without being bound by theory, these novel peaks observed in Regime I and Regime VI relate to the properties of the silicon impregnated into the porous carbon scaffold, i.e., related to the interactions between and among the properties of the porous carbon scaffold, the silicon impregnated into the porous carbon scaffold via CVI, and lithium. In order to provide a quantitative analysis, we herein define the parameter φ, which is calculated as the normalized peak I with respect to peak III as:

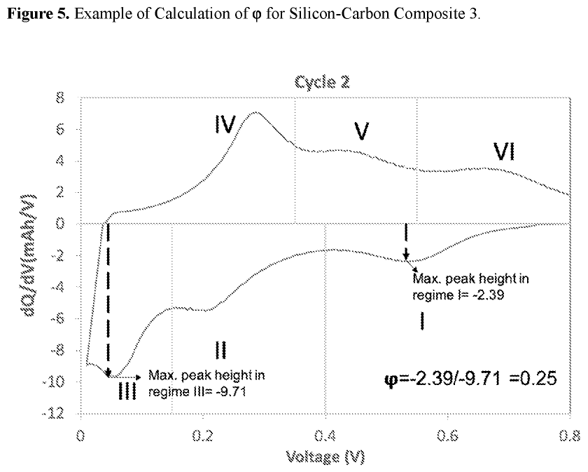

φ=(Max peak height dQ/dV in Regime I)/(Max peak height dQ/dV in Regime III)

where dQ/dV is measured in a half-cell coin cell, and regime I is 0.8V−0.4V and Regime III is 0.15V−0V; the half-cell coin cell is produced as known in the art. If the Si—C sample shows peaks associated with graphite in regime III of the differential curve, it is omitted in favor of Li—Si related phase transition peaks for the calculation of D factor. For this example, the half-cell coin cell comprises an anode comprising 60-90% silicon-carbon composite, 5-20% SBR-Na-CMC, and 5-20% Super C45. An example for φ calculation is shown in FIG. 5 for Silicon-Carbon Composite 3. In this instance, the maximum peak height in the regime I is −2.39 and is found at voltage 0.53V. Similarly, maximum peak height in regime III is −9.71 at 0.04V. In this instance, φ can be calculated using the above formula, yielding φ=−2.39/−9.71=0.25. The value of φ was determined from the half-cell coin cell data for the various silicon-carbon composites presented in Example 2. These data are summarized in Table 6.

TABLE 6
Properites of various silicon-carbon materials.

| Silicon- | | | | | | |
|---|---|---|---|---|---|---|
| Carbon | Carbon | Surface | Si | | Average | |
| Composite | Scaffold | Area | content | | CE | |
| # | # | (m2/g) | (%) | Z | (7-20) | φ |
| 1 | 1 | 7 | 45.0 | 0.2 | 0.9981 | 0.24 |
| 2 | 1 | 7 | 45.4 | 0.6 | 0.9980 | 0.24 |
| 3 | 1 | 6 | 45.8 | 0.6 | 0.9975 | 0.25 |
| 4 | 2 | 3.06 | 50.1 | 1.0 | 0.9969 | 0.18 |
| 5 | 2 | 1.96 | 51.3 | 2.0 | 0.9974 | 0.18 |
| 6 | 3 | 140 | 43.1 | 3.2 | 0.9941 | 0.13 |
| 7 | 2 | 1.61 | 48.7 | 2.8 | 0.9977 | 0.19 |
| 8 | 2 | 2 | 48.5 | 3.0 | 0.9972 | 0.19 |
| 9 | 1 | 8 | 46.3 | 0.2 | 0.9976 | 0.20 |
| 10 | 4 | 44 | 51.2 | 6.2 | 0.9975 | 0.13 |
| 11 | 5 | 94 | 48.9 | 6.2 | 0.9969 | 0.15 |
| 12 | 6 | 61 | 52.1 | 10.6 | 0.9869 | 0 |
| 13 | 7 | 68.5 | 34.6 | 17.2 | 0.9909 | 0 |
| 14 | 8 | 20 | 74 | 33.5 | 0.9717 | 0 |
| 15 | 8 | 149 | 57.7 | 34.5 | 0.9766 | 0 |
| 16 | 8 | 61.7 | 68.9 | 38.7 | 0.9757 | 0 |
| 17 | 9 | 11 | 46.1 | 0.8 | 0.9990 | 0.35 |
| 18 | 9 | 11 | 46.7 | 2.0 | 0.9985 | 0.34 |
| 19 | 9 | 15.1 | 46.8 | 1.7 | Pending | Pending |
| 20 | 9 | 4.1 | 47.9 | 4.2 | Pending | 0.34 |
| 21 | 9 | 5 | 48.1 | 4.6 | Pending | 0.32 |

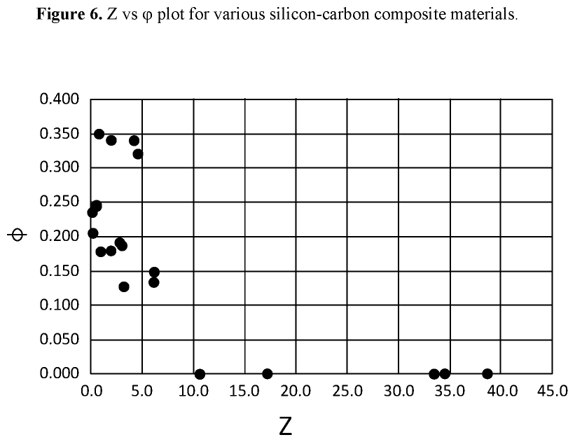

The data in Table 6 reveal an unexpected relationship between decreasing Z and increasing φ. All silicon-carbon composites with Z<10 had φ≥0.13, and all silicon-carbon composites with Z>10 had φ<0.13, indeed, all silicon-carbon composites with where Z>10 had φ=0. This relationship is also evidenced in FIG. 6. Without being bound by theory, silicon materials comprising φ≥0.10, for example φ≥0.13, correspond to a novel form of silicon. Alternatively, silicon materials comprising φ>0 correspond to a novel form of silicon. Without being bound by theory, silicon materials comprising φ>0 are characteristic to silicon material wherein the silicon is amorphous, nano-sized silicon confined within pores, for example pores of a porous carbon scaffold. The silicon-carbon composite material comprising silicon comprising φ≥0.10, for example φ≥0.13, corresponds to a novel silicon-carbon composite material. Alternatively, silicon-carbon composite materials comprising φ>0 corresponds to a novel silicon-carbon composite material.

In certain embodiments, the silicon-carbon composite comprises a φ≥0.1, φ≥0.11, φ≥0.12, φ≥0.13, φ≥0.14, φ≥0.15, φ≥0.16, φ≥0.17, φ≥0.18, φ≥0.19, φ≥0.20, φ≥0.24, φ≥0.24, φ≥0.25, φ≥0.30 or φ≥0.35. Im come embodiment, φ>0. In some embodiments, φ≥0.001, φ≥0.01, φ≥0.02, φ≥0.05, φ≥0.1, φ≥0.11, or φ≥0.12.

In certain embodiments, the silicon-carbon composite material comprises a Z less than 10 and a carbon scaffold with >70% microporosity, and wherein the silicon-carbon composite also comprises 30%-60% silicon, and surface area less than 100 m2/g, and φ≥0.1, for example Z less than 10 and >70% microporosity, and wherein the silicon-carbon composite also comprises 30%-60% silicon, and surface area less than 50 m2/g, and φ≥0.1, for example Z less than 10 and >70% microporosity, and wherein the silicon-carbon composite also comprises 30%-60% silicon, and surface area less than 30 m2/g, and φ≥0.1, for example Z less than 10 and >70% microporosity, and wherein the silicon-carbon composite also comprises 30%-60% silicon, and surface area less than 10 m2/g, and φ≥0.1, for example Z less than 10 and >70% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >70% microporosity, and wherein the silicon-carbon composite also comprises 40%-60% silicon, and surface area less than 100 m2/g, and φ≥0.1, for example Z less than 10 and >70% microporosity, and wherein the silicon-carbon composite also comprises 40%-60% silicon, and surface area less than 50 m2/g, and φ≥0.1, for example Z less than 10 and >70% microporosity, and wherein the silicon-carbon composite also comprises 40%-60% silicon, and surface area less than 30 m2/g, and φ≥0.1, for example Z less than 10 and >70% microporosity, and wherein the silicon-carbon composite also comprises 40%-60% silicon, and surface area less than 10 m2/g, and φ≥0.1, for example Z less than 10 and >70% microporosity, and wherein the silicon-carbon composite also comprises 40%-60% silicon, and surface area less than 5 m2/g, and φ≥0.1.

In certain embodiments, the silicon-carbon composite material comprises a Z less than 10 and a carbon scaffold with >70% microporosity, and wherein the silicon-carbon composite also comprises 30%-60% silicon, and surface area less than 100 m2/g, and φ>0, for example Z less than 10 and >70% microporosity, and wherein the silicon-carbon composite also comprises 30%-60% silicon, and surface area less than 50 m2/g, and φ>0, for example Z less than 10 and >70% microporosity, and wherein the silicon-carbon composite also comprises 30%-60% silicon, and surface area less than 30 m2/g, and φ>0, for example Z less than 10 and >70% microporosity, and wherein the silicon-carbon composite also comprises 30%-60% silicon, and surface area less than 10 m2/g, and φ>0, for example Z less than 10 and >70% microporosity, and wherein the silicon-carbon composite also comprises 30%-60% silicon, and surface area less than 5 m2/g, and φ>0.

In certain embodiments, the silicon-carbon composite material comprises a Z less than 10 and a carbon scaffold with >70% microporosity, and wherein the silicon-carbon composite also comprises 40%-60% silicon, and surface area less than 100 m2/g, and φ>0, for example Z less than 10 and >70% microporosity, and wherein the silicon-carbon composite also comprises 40%-60% silicon, and surface area less than 50 m2/g, and φ>0, for example Z less than 10 and >70% microporosity, and wherein the silicon-carbon composite also comprises 40%-60% silicon, and surface area less than 30 m2/g, and φ>0, for example Z less than 10 and >70% microporosity, and wherein the silicon-carbon composite also comprises 40%-60% silicon, and surface area less than 10 m2/g, and φ>0, for example Z less than 10 and >70% microporosity, and wherein the silicon-carbon composite also comprises 40%-60% silicon, and surface area less than 5 m2/g, and φ≥0.

In certain embodiments, the silicon-carbon composite material comprises a Z less than 10 and a carbon scaffold with >80% microporosity, and wherein the silicon-carbon composite also comprises 30%-60% silicon, and surface area less than 100 m2/g, and φ≥0.1, for example Z less than 10 and >80% microporosity, and wherein the silicon-carbon composite also comprises 30%-60% silicon, and surface area less than 50 m2/g, and φ≥0.1, for example Z less than 10 and >80% microporosity, and wherein the silicon-carbon composite also comprises 30%-60% silicon, and surface area less than 30 m2/g, and φ≥0.1, for example Z less than 10 and >80% microporosity, and wherein the silicon-carbon composite also comprises 30%-60% silicon, and surface area less than 10 m2/g, and φ≥0.1, for example Z less than 10 and >80% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >80% microporosity, and wherein the silicon-carbon composite also comprises 40%-60% silicon, and surface area less than 100 m2/g, and φ≥0.1, for example Z less than 10 and >80% microporosity, and wherein the silicon-carbon composite also comprises 40%-60% silicon, and surface area less than 50 m2/g, and φ≥0.1, for example Z less than 10 and >80% microporosity, and wherein the silicon-carbon composite also comprises 40%-60% silicon, and surface area less than 30 m2/g, and φ≥0.1, for example Z less than 10 and >80% microporosity, and wherein the silicon-carbon composite also comprises 40%-60% silicon, and surface area less than 10 m2/g, and φ≥0.1, for example Z less than 10 and >80% microporosity, and wherein the silicon-carbon composite also comprises 40%-60% silicon, and surface area less than 5 m2/g, and φ≥0.1.

In certain embodiments, the silicon-carbon composite material comprises a Z less than 10 and a carbon scaffold with >80% microporosity, and wherein the silicon-carbon composite also comprises 30%-60% silicon, and surface area less than 100 m2/g, and φ>0, for example Z less than 10 and >80% microporosity, and wherein the silicon-carbon composite also comprises 30%-60% silicon, and surface area less than 50 m2/g, and φ>0, for example Z less than 10 and >80% microporosity, and wherein the silicon-carbon composite also comprises 30%-60% silicon, and surface area less than 30 m2/g, and φ>0, for example Z less than 10 and >80% microporosity, and wherein the silicon-carbon composite also comprises 30%-60% silicon, and surface area less than 10 m2/g, and φ>0, for example Z less than 10 and >80% microporosity, and wherein the silicon-carbon composite also comprises 30%-60% silicon, and surface area less than 5 m2/g, and φ≥0.

In certain embodiments, the silicon-carbon composite material comprises a Z less than 10 and a carbon scaffold with >80% microporosity, and wherein the silicon-carbon composite also comprises 40%-60% silicon, and surface area less than 100 m2/g, and φ≥0, for example Z less than 10 and >80% microporosity, and wherein the silicon-carbon composite also comprises 40%-60% silicon, and surface area less than 50 m2/g, and φ≥0, for example Z less than 10 and >80% microporosity, and wherein the silicon-carbon composite also comprises 40%-60% silicon, and surface area less than 30 m2/g, and φ≥0, for example Z less than 10 and >80% microporosity, and wherein the silicon-carbon composite also comprises 40%-60% silicon, and surface area less than 10 m2/g, and φ>0, for example Z less than 10 and >80% microporosity, and wherein the silicon-carbon composite also comprises 40%-60% silicon, and surface area less than 5 m2/g, and φ>0.

In certain embodiments, the silicon-carbon composite material comprises a Z less than 10 and a carbon scaffold with >90% microporosity, and wherein the silicon-carbon composite also comprises 30%-60% silicon, and surface area less than 100 m2/g, and φ≥0.1, for example Z less than 10 and >90% microporosity, and wherein the silicon-carbon composite also comprises 30%-60% silicon, and surface area less than 50 m2/g, and φ≥0.1, for example Z less than 10 and >90% microporosity, and wherein the silicon-carbon composite also comprises 30%-60% silicon, and surface area less than 30 m2/g, and φ≥0.1, for example Z less than 10 and >90% microporosity, and wherein the silicon-carbon composite also comprises 30%-60% silicon, and surface area less than 10 m2/g, and φ≥0.1, for example Z less than 10 and >90% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >90% microporosity, and wherein the silicon-carbon composite also comprises 40%-60% silicon, and surface area less than 100 m2/g, and φ≥0.1, for example Z less than 10 and >90% microporosity, and wherein the silicon-carbon composite also comprises 40%-60% silicon, and surface area less than 50 m2/g, and φ≥0.1, for example Z less than 10 and >90% microporosity, and wherein the silicon-carbon composite also comprises 40%-60% silicon, and surface area less than 30 m2/g, and φ≥0.1, for example Z less than 10 and >90% microporosity, and wherein the silicon-carbon composite also comprises 40%-60% silicon, and surface area less than 10 m2/g, and φ≥0.1, for example Z less than 10 and >90% microporosity, and wherein the silicon-carbon composite also comprises 40%-60% silicon, and surface area less than 5 m2/g, and φ≥0.1.

In certain embodiments, the silicon-carbon composite material comprises a Z less than 10 and a carbon scaffold with >90% microporosity, and wherein the silicon-carbon composite also comprises 30%-60% silicon, and surface area less than 100 m2/g, and φ≥0, for example Z less than 10 and >90% microporosity, and wherein the silicon-carbon composite also comprises 30%-60% silicon, and surface area less than 50 m2/g, and φ≥0, for example Z less than 10 and >90% microporosity, and wherein the silicon-carbon composite also comprises 30%-60% silicon, and surface area less than 30 m2/g, and φ≥0, for example Z less than 10 and >90% microporosity, and wherein the silicon-carbon composite also comprises 30%-60% silicon, and surface area less than 10 m2/g, and φ>0, for example Z less than 10 and >90% microporosity, and wherein the silicon-carbon composite also comprises 30%-60% silicon, and surface area less than 5 m2/g, and φ>0.

In certain embodiments, the silicon-carbon composite material comprises a Z less than 10 and a carbon scaffold with >90% microporosity, and wherein the silicon-carbon composite also comprises 40%-60% silicon, and surface area less than 100 m2/g, and φ>0, for example Z less than 10 and >90% microporosity, and wherein the silicon-carbon composite also comprises 40%-60% silicon, and surface area less than 50 m2/g, and φ>0, for example Z less than 10 and >90% microporosity, and wherein the silicon-carbon composite also comprises 40%-60% silicon, and surface area less than 30 m2/g, and φ>0, for example Z less than 10 and >90% microporosity, and wherein the silicon-carbon composite also comprises 40%-60% silicon, and surface area less than 10 m2/g, and φ>0, for example Z less than 10 and >90% microporosity, and wherein the silicon-carbon composite also comprises 40%-60% silicon, and surface area less than 5 m2/g, and φ>0.

In certain embodiments, the silicon-carbon composite material comprises a Z less than 10 and a carbon scaffold with >95% microporosity, and wherein the silicon-carbon composite also comprises 30%-60% silicon, and surface area less than 100 m2/g, and φ≥0.1, for example Z less than 10 and >95% microporosity, and wherein the silicon-carbon composite also comprises 30%-60% silicon, and surface area less than 50 m2/g, and φ≥0.1, for example Z less than 5 and >95% microporosity, and wherein the silicon-carbon composite also comprises 30%-60% silicon, and surface area less than 30 m2/g, and φ≥0.1, for example Z less than 10 and >95% microporosity, and wherein the silicon-carbon composite also comprises 30%-60% silicon, and surface area less than 10 m2/g, and φ≥0.1, for example Z less than 10 and >95% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >95% microporosity, and wherein the silicon-carbon composite also comprises 40%-60% silicon, and surface area less than 100 m2/g, and φ≥0.1, for example Z less than 10 and >95% microporosity, and wherein the silicon-carbon composite also comprises 40%-60% silicon, and surface area less than 50 m2/g, and φ≥0.1, for example Z less than 10 and >95% microporosity, and wherein the silicon-carbon composite also comprises 40%-60% silicon, and surface area less than 30 m2/g, and φ≥0.1, for example Z less than 10 and >95% microporosity, and wherein the silicon-carbon composite also comprises 40%-60% silicon, and surface area less than 10 m2/g, and φ≥0.1, for example Z less than 10 and >95% microporosity, and wherein the silicon-carbon composite also comprises 40%-60% silicon, and surface area less than 5 m2/g, and φ≥0.1.

In certain embodiments, the silicon-carbon composite material comprises a Z less than 10 and a carbon scaffold with >95% microporosity, and wherein the silicon-carbon composite also comprises 30%-60% silicon, and surface area less than 100 m2/g, and φ≥0.1, for example Z less than 10 and >95% microporosity, and wherein the silicon-carbon composite also comprises 30%-60% silicon, and surface area less than 50 m2/g, and φ≥0.1, for example Z less than 10 and >95% microporosity, and wherein the silicon-carbon composite also comprises 30%-60% silicon, and surface area less than 30 m2/g, and φ≥0.1, for example Z less than 10 and >95% microporosity, and wherein the silicon-carbon composite also comprises 30%-60% silicon, and surface area less than 10 m2/g, and φ≥0.1, for example Z less than 10 and >95% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >95% microporosity, and wherein the silicon-carbon composite also comprises 40%-60% silicon, and surface area less than 100 m2/g, and φ>0, for example Z less than 10 and >95% microporosity, and wherein the silicon-carbon composite also comprises 40%-60% silicon, and surface area less than 50 m2/g, and φ>0, for example Z less than 10 and >95% microporosity, and wherein the silicon-carbon composite also comprises 40%-60% silicon, and surface area less than 30 m2/g, and φ>0, for example Z less than 10 and >95% microporosity, and wherein the silicon-carbon composite also comprises 40%-60% silicon, and surface area less than 10 m2/g, and φ>0, for example Z less than 10 and >95% microporosity, and wherein the silicon-carbon composite also comprises 40%-60% silicon, and surface area less than 5 m2/g, and φ≥0.

### Example 4. Particle Size Distribution for Various Carbon Scaffold Materials

The particle size distribution for the various carbon scaffold materials was determined by using a laser diffraction particle size analyzer as known in the art. Table 7 presented the data, specifically the Dv,1, Dv10, Dv50, and Dv,90, and Dv,100.

TABLE 7
Properites of various carbon scaffold materials.

| Carbon | |
|---|---|
| Scaffold # | Particle Size Characteristics |
| 1 | Dv, 1 = 1.2 μm, Dv, 10 = 2.5 μm, Dv, 50 = 6.9 μm, |
| | Dv90 = 11.5 μm, Dv100 = 20.1 μm |
| 2 | Dv, 1= 1.09, Dv10 = 3.4 μm, Dv50 = 7.67 μm, |
| | Dv, 90 = 13.3 μm, Dv100 = 17.8 |
| 4 | Dv, 1 = 0.81, Dv10 = 1.9 μm, Dv50 = 6.4 μm, |
| | Dv, 90 = 16.6 μm, Dv100 = 26.5 |
| 5 | Dv, 1 = 0.62, Dv10 = 1.1 μm, Dv50 = 4.2 μm, |
| | Dv, 90 = 15.8 μm, Dv100 = 29.8 |
| 8 | Dv, 1 = 1.3, Dv10 = 3.7 μm, Dv50 = 16 μm, |
| | Dv, 90 = 35.2 μm, Dv100 = 50.7 |
| 9 | Dv, 1 = 1.2 μm, Dv, 10 = 2.7 μm, Dv, 50 = 7.6 μm, |
| | Dv, 90 = 12.3 μm, Dv100 = 20.7 μm |

### Example 5. Determination of Graphitic Nature of Porous Carbon Scaffold by Raman Spectroscopy

A variety of porous carbon scaffold samples were produced by solvent-free processing by mixing solid carbon precursors bisphenol A (BPA) and hexamethylenetetramine (HMT), and heating to 650-1100° C. and holding for dwell time of 1 to 6 h, using a process gas comprising nitrogen, carbon dioxide, steam, or combinations thereof. Table 8 presents properties of these porous carbon scaffolds, including the mass ration of precursors BPA:HMT employed for solventless processing, and, for the resulting porous carbon scaffold, the surface area and pore volume determined from nitrogen sorption analysis and I_{D}/I_{G} determined from Raman spectroscopy. For preparing Carbon Scaffold Sample 14, the carbon precursors were polymerized by heating to 150 to 250° C. for several hours prior to carbonization.

TABLE 8
Properites of various carbon scaffold materials.

| Carbon | Mass ratio of | Surface | Pore | |
|---|---|---|---|---|
| Scaffold | precursors | Area | Volume | |
| # | BPA:HMT | (m2/g) | (cm3/g) | I_{D}/I_{G} |
| 10 | 1:3 | 1316 | 0.536 | 0.85 |
| 11 | 2.44:1 | 1622 | 0.700 | 0.80 |
| 12 | 9:1 | 522 | 0.219 | 0.79 |
| 13 | 2.44 | 787 | 0.367 | 0.78 |
| 14 | 3:1 | 1824 | 0.894 | 0.88 |
| 15 | 3:1 | 629 | 0.266 | 0.79 |

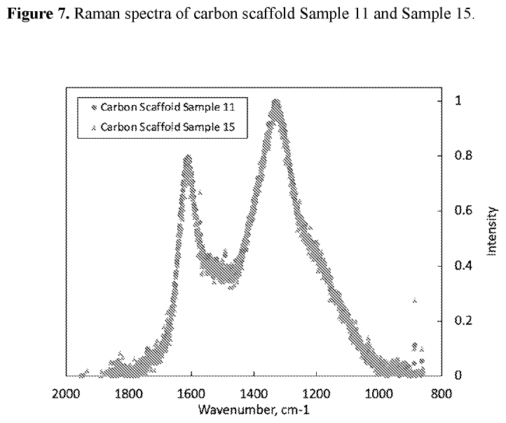

A comparative analysis of the Raman spectra of Carbon Scaffold Sample 11 and Carbon Scaffold Sample 15 is shown in FIG. 7. For these samples, the mass ratio of precursors BPA and HMT were in the range of 2.44:1 to 3:1, and the process gas was varied, specifically for processing Carbon Scaffold Sample 11 the process gas comprised CO2 and for processing Carbon Scaffold Sample 15 the process gas comprised steam. For these two samples, the measured I_{D}/I_{G} are similar (in the range of 0.79 to 0.80), thus these two samples comprise similar graphitic nature.

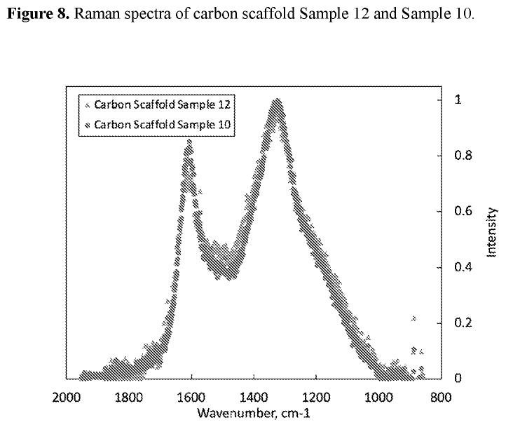

A comparative analysis of the Raman spectra of Carbon Scaffold Sample 12 and Carbon Scaffold Sample 10 is shown in FIG. 8. For these samples, the mass ratio of precursors BPA and HMT was varied from 9:1 (Carbon Scaffold Sample 12) to 1:3 (Carbon Scaffold Sample 10), and the process gas for both samples comprised steam. Carbon Scaffold Sample 12 comprised a lower I_{D}/I_{G} (0.79) compared to Carbon Scaffold Sample 10 (I_{D}/I_{G}=0.85), thus the Carbon Scaffold Sample 12 comprises a higher graphitic extent compared to Carbon Scaffold Sample 10.

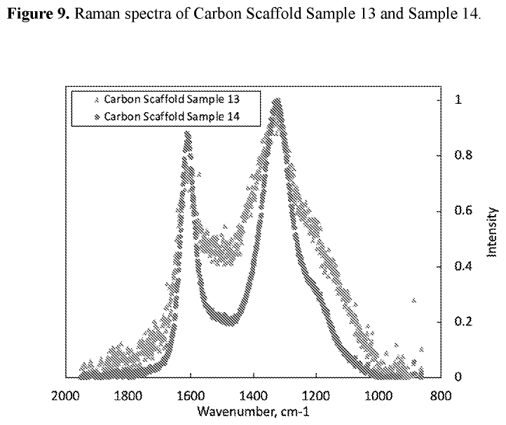

A comparative analysis of the Raman spectra of Carbon Scaffold Sample 13 and Carbon Scaffold Sample 14 is shown in FIG. 9. For these samples, the mass ratio of precursors BPA and HMT were in the range of 2.44:1 to 3:1, the process gas was varied, specifically the process gas for preparing Carbon Scaffold Sample 13 comprised CO2 and the process gas for preparing Carbon Scaffold Sample 14 comprised steam, and for the preparation of Carbon Scaffold Sample 14, there was a polymer step carried out before carbonization. As can be seen, Carbon Scaffold Sample 13 comprised a higher I_{D}/I_{G} (0.78) compared to Carbon Scaffold Sample 14 (I_{D}/I_{G}=0.88), thus Carbon Scaffold Sample 13 comprises a higher graphitic extent compared to Carbon Scaffold Sample 14. Without being bound by theory, the polymerization step carried out prior to carbonization for preparing Carbon Scaffold Sample 14 resulted in greater extent of polymer growth relative to polymer nucleation, and thus fewer defects in the polymer structure and fewer defects in the carbon structure of the resulting porous carbon scaffold. Accordingly, the extents of defects in the carbon structure for Carbon Scaffold Sample 13 is relatively higher. Without being bound by theory, the greater extent of defects in the carbon structure for Carbon Scaffold Sample 13 provide for more tendency for this sample to graphitize, consistent with the lower I_{D}/I_{G} determined for this sample.

The silicon-carbon composite particles can be prepared from the mixture of solid carbon precursor materials according to various embodiments with various ordering of the various process steps. Examples of such embodiments is presented in Table 9. For clarity, note that each process sequence, the sequence is carried out for processing a mixture of carbon precursors, whose polymerization is carried out either as separate step before proceeding to pyrolysis, or occurs within the pyrolysis step.

TABLE 9
Various embodiments to prepare silicon-compsoite particles
with various ordering of the various process steps.

| Process | | | | | |
|---|---|---|---|---|---|
| Sequence | Step 1 | Step 2 | Step 3 | Step 4 | Step 5 |
| 1 | Pyrolysis | Graphitization | Activation | Comminution | CVI |
| 2 | Pyrolysis | Graphitization | Comminution | Activation | CVI |
| 3 | Pyrolysis | Activation | Graphitization | Comminution | CVI |
| 4 | Pyrolysis | Activation | Comminution | Graphitization | CVI |
| 5 | Pyrolysis | Comminution | Activation | Graphitization | CVI |
| 6 | Pyrolysis | Comminution | Graphitization | Activation | CVI |
| 7 | Combined | Graphitization | Comminution | CVI | N/A |
| | pyrolysis and | | | | |
| | activation | | | | |
| 8 | Combined | Comminution | Graphitization | CVI | N/A |
| | pyrolysis and | | | | |
| | activation | | | | |

For all the above process sequences embodied, the graphitic nature of the porous carbon scaffold is determined by calculation of I_{D}/I_{G} from the Raman spectra. In some embodiments, the silicon-carbon composite comprises a porous carbons scaffold comprising I_{D}/I_{G}<0.9, for example I_{D}/I_{G}<0.8, for example I_{D}/I_{G}<0.7, for example I_{D}/I_{G}<0.6, for example I_{D}/I_{G}<0.5, for example I_{D}/I_{G}<0.4, for example I_{D}/I_{G}<0.3, for example I_{D}/I_{G}<0.2, for example I_{D}/I_{G}<0.1, for example I_{D}/I_{G}<0.01, for example I_{D}/I_{G}<0.001.

### Example 6. Demonstration of Reduction of Carbon Specific Surface Area and Total Pore Volume Resulting from Graphitization Treatment

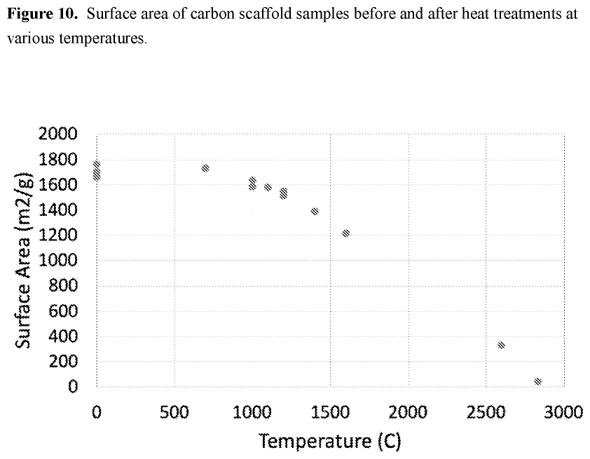

Various pyrolyzed and activated carbons with starting specific surface area in the range of 500-2000 m2/g were subject to treatment under inert gas (e.g., nitrogen or argon) at temperatures ranging from 1000° C. to 2850° C. for times of 1-6 h. As shown in FIG. 10, there was a reduction in specific surface area with increasing treatment temperature, consistent with carbon graphitization.

Representative data are presented in Table 10 for several pyrolyzed carbon materials in addition to pyrolyzed and activated carbon materials. These carbon materials were subjected to heat treatment as described above, and the resulting data for the materials after treatment are presented in Table 11.

TABLE 10
Various carbon materials

| | | Total | Micro-/ | | |
|---|---|---|---|---|---|
| Carbon | Surface | Pore | Meso-/ | | |
| Scaffold | Area | Volume | Macropores | Lₐ | |
| # | (m2/g) | (cm3/g) | (%) | (A) | I_{D}/I_{G} |
| 16 | 1662 | 0.771 | 79/21/0 | 15 | 2.6 |
| 17 | 1609 | 0.698 | 91/9/0 | NA | NA |
| 18 | 1631 | 0.804 | 86/14/0 | NA | NA |
| 19 | 522 | 0.219 | 99/1/0 | NA | 0.79 |
| 20 | 1733 | 0.782 | 88/12/0 | 16 | NA |

TABLE 11
Various carbon materials after graphitization treatment.

| | | | | | Micro-/ | | |
|---|---|---|---|---|---|---|---|
| | Base | Treat- | | Total | Meso-/ | | |
| Treated | Carbon | ment | Surface | Pore | Macro- | | |
| Carbon | Scaffold | Temp. | Area | Volume | pores | Lₐ | I_{D}/ |
| Scaffold | # | (C.) | (m2/g) | (cm3/g) | (%) | (A) | I_{G} |
| 1 | 16 | 2600 | 325 | 0.303 | 50/50/0 | 5.6 | 0.9 |
| 2 | 16 | 2800 | 38.5 | 0.044 | 31/69/0 | 25.4 | 0.3 |
| 3 | 17 | 1200 | 1549 | 0.71 | 86/14/0 | 20.8 | NA |
| 4 | 17 | 1400 | 1387 | 0.65 | 81/19/0 | 23.8 | NA |
| 5 | 17 | 1600 | 1213 | 0.58 | 76/24/0 | 28.8 | NA |
| 6 | 20 | 2800 | 5.5 | 0.16 | 44/56/0 | NA | NA |
| 7 | 18 | 2800 | 18.8 | 0.049 | 4/96/0 | NA | NA |
| 8 | 19 | 2800 | 5.7 | 0.012 | 7/93/0 | 5.7 | 0.8 |

NA denotes data not available.

In Table 11, I_{D}/I_{G} data were calculated from Raman spectroscopy and the graphite crystallite size (La) data were calculated by XRD as known in the art. The reduction in pore volume with increasing temperature favored retaining meso and macropores, whereas micropores were decreased. The I_{D}/I_{G} ratio increased with increasing temperature, corresponding to the transition from amorphous carbon to graphitic nature. The graphite crystallite size calculated from XRD increased with increasing temperature, also indicating the transition from amorphous carbon to graphitic nature.

The sheet resistance was measured for Carbon Scaffold 17 and Carbon Scaffold 18 were measured according to the sheet resistance method. The sheet resistance methods involves preparing a slurry of the carbon scaffold, a polymeric binder, and deionized water to cast as a thin film. A four point probe is then used to measure sheet resistance by applying a DC current to the outer 2 probes and measuring the voltage drop across the 2 middle probes. Sheet resistance is then calculated by

$$R s = \frac{π * Δ V}{ln ( 2 ) * I} . \qquad ( 2 )$$

The sheet resistance for Carbon Scaffold 17 and Carbon Scaffold 18 were 411 and 220 Ohm/cm2, respectively. In contrast, the treated carbon scaffolds exhibited reduced sheet resistivity, consistent with graphitic carbon nature. For example, Treated Carbon Scaffold 8 had a sheet resistivity of only 26 Ohn/cm2.

The pycnometry density for Treated Carbon Scaffold 6, Treated Carbon Scaffold 7, and Treated Carbon Scaffold 8, were 1.67 g/cm3, 1.52 g/cm3, and 1.75 g/cm3. Surprisingly, these data are far lower than the theoretical value for graphite. Without being bound by theory, such low pycnometry density reflects porosity residing within the graphitic carbon. In some embodiments, the treated carbon scaffold exhibits a pycnometry density of less than 2.0 g/cm3, for example less than 1.9 g/cm3, for example less than 1.8 g/cm3, for example less than 1.7 g/cm3, for example less than 1.6 g/cm3, for example less than 1.5 g/cm3, for example less than 1.4 g/cm3.

### Example 7. Production of Silicon-Carbon Composites from Heat Treated Porous Carbon Scaffold Materials

Various silicon carbon composites were produced by contacting heat treated porous carbon scaffold at elevated temperature in the presence of silane gas as generally disclosed herein. A variety of process sequences were employed, according to those defined in Table 9. Physiochemical and electrochemical characterization data for these silicon-carbon composite materials are presented in Table 12 and Table 13, respectively.

TABLE 12
Physicochemical properites of various silicon-carbon materials.

| Silicon- | Base | | | | |
|---|---|---|---|---|---|
| Carbon | Carbon | | Surface | Si | |
| Composite | Scaffold | Process | Area | content | |
| # | # | Sequence | (m2/g) | (%) | Z |
| 22 | 17 (treated | 4 | 5.6 | 41 | 4.1 |
| | scaffold | | | | |
| | #3 | | | | |
| 23 | 17 (treated | 4 | 9.8 | 31 | 1.7 |
| | scaffold | | | | |
| | #4 | | | | |
| 24 | 17 (treated | 4 | 69 | 22 | 0.59 |
| | scaffold | | | | |
| | #5 | | | | |

TABLE 13
Electrochemical properites of various silicon-carbon materials.

| Silicon- | | | | |
|---|---|---|---|---|
| Carbon | First Cycle | Max | | |
| Composite | Efficiency | Capacity | Average CE | |
| # | (%) | (mAh/g) | (7-20) | φ |
| 22 | 90 | 1428 | 0.999 | 0.29 |
| 23 | 75 | 830 | 0.998 | 0.24 |
| 24 | 72 | 668 | 0.999 | 0.22 |

### Example 8. Comparison of Post-Graphitization Activation for Carbons with Varying Pore Volume

For this example, we compared two different process sequences by characterizing the carbons scaffolds created therein. To this end, we studied Treated Carbon Scaffold 1 and Treated Carbon Scaffold 2 (both were the created via processing carbon precursors progressing from polymerization to pyrolysis to activation to comminution to heat treatment to accomplish graphitization) in comparison to Treated Carbon Scaffold 8 (created via processing carbon precursors progressing from polymerization to pyrolysis to comminution to heat treatment to accomplish graphitization. It was observed that Treated Carbon Scaffold 1 and Treated Carbon Scaffold 2 were unable to be activated, i.e., the resulting surface area and pore volume after 4-6 hours at 900-950 C in the presence of activation gas (steam and/or carbon dioxide) was only 13 m2/g and 0.0206 cm3/g, and 1.86 m2/g and 0.0024 cm3/g, respectively, in both cases a substantial decrease rather than increase in surface area and pore volume. It was a surprising and unexpected result that Treated Carbon Scaffold 8 was able to achieve increased surface area and pore volume under similar conditions, specifically the resulting values were 40.5 m2/g and 0.0539 cm3/g. Without being bound by theory, the graphitization of pyrolyzed carbon results in a carbon that, upon subsequent activation, can be converted to high surface area and pore volume, for example greater than 40 m2/g and greater than 0.05 cm3/g, for example greater than 80 m2/g and greater than 0.1 cm3/g, for example greater than 400 m2/g and greater than 0.5 cm3/g, for example greater than 500 m2/g and greater than 0.6 cm3/g, for example greater than 1000 m2/g and greater than 0.5 cm3/g, for example greater than 1500 m2/g and greater than 0.6 cm3/g.

### EXPRESSED EMBODIMENTS

Embodiment 1. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas;
d. comminuting the activated carbon material;
e. graphitizing the porous carbon scaffold particles at a temperature of 1200 C to 3000 C in the presence on an inert gas;
f. heating the porous carbon scaffold particles to a temperature of 400° C. to 525° C. in the presence of silane gas; and
g. wherein the silicon-carbon composite comprises:
   i. a carbon scaffold comprising I_{D}/I_{G} less than or equal to 0.9 and a pore volume, wherein the pore volume comprises greater than 70% microporosity.

Embodiment 2. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas;
d. comminuting the activated carbon material at a temperature of 1200 C to 3000 C in the presence on an inert gas;
e. graphitizing the porous carbon scaffold particles;
f. heating the porous carbon scaffold particles to a temperature of 350° C. to 550° C. in the presence of silane gas; and
g. wherein the silicon-carbon composite comprises:
   i. a carbon scaffold comprising I_{D}/I_{G} less than or equal to 0.9 and a pore volume, wherein the pore volume comprises greater than 70% microporosity; and
   ii. a φ of greater than or equal to 0.1, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

Embodiment 3. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas;
d. comminuting the activated carbon material;
e. graphitizing the porous carbon scaffold particles at a temperature of 1200 C to 3000 C in the presence on an inert gas;
f. heating the porous carbon scaffold particles to a temperature of 350° C. to 550° C. in the presence of silane gas; and
g. wherein the silicon-carbon composite comprises:
   i. a carbon scaffold comprising I_{D}/I_{G} less than or equal to 0.9 and a pore volume, wherein the pore volume comprises greater than 50% microporosity; and
   ii. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis.

Embodiment 4. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas
d. comminuting the activated carbon material
e. graphitizing the porous carbon scaffold particles at a temperature of 1200 C to 3000 C in the presence on an inert gas;
f. heating the porous carbon scaffold particles to a temperature of 350° C. to 550° C. in the presence of silane gas; and
g. wherein the silicon-carbon composite comprises:
   i. a carbon scaffold comprising I_{D}/I_{G}<0.9 and a pore volume, wherein the pore volume comprises greater than 70% microporosity; and
   ii. a silicon content of 30% to 60% by weight;
   iii. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis;
   iv. a surface area less than 30 m2/g; and
   v. a φ of greater than or equal to 0.1, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

Embodiment 5. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas
d. graphitizing the activated carbon material at a temperature of 1200 C to 3000 C in the presence on an inert gas;
e. comminuting the porous carbon scaffold
f. heating the porous carbon scaffold particles to a temperature of 350° C. to 550° C. in the presence of silane gas; and
g. wherein the silicon-carbon composite comprises:
   i. a carbon scaffold comprising I_{D}/I_{G}<0.9 and a pore volume, wherein the pore volume comprises greater than 70% microporosity.

Embodiment 6. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas
d. graphitizing the activated carbon material at a temperature of 1200 C to 3000 C in the presence on an inert gas;
e. comminuting the porous carbon scaffold
f. heating the porous carbon scaffold particles to a temperature of 350° C. to 550° C. in the presence of silane gas; and
g. wherein the silicon-carbon composite comprises:
   i. a carbon scaffold comprising I_{D}/I_{G}<0.9 and a pore volume, wherein the pore volume comprises greater than 70% microporosity; and
   ii. a φ of greater than or equal to 0.1, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

Embodiment 7. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas
d. graphitizing the activated carbon material at a temperature of 1200 C to 3000 C in the presence on an inert gas;
e. comminuting the porous carbon scaffold
f. heating the porous carbon scaffold particles to a temperature of 350° C. to 550° C. in the presence of silane gas; and
g. wherein the silicon-carbon composite comprises:
   i. a carbon scaffold comprising I_{D}/I_{G}<0.9 and a pore volume, wherein the pore volume comprises greater than 70% microporosity; and
   ii. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis.

Embodiment 8. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas
d. graphitizing the activated carbon material at a temperature of 1200 C to 3000 C in the presence on an inert gas;
e. comminuting the porous carbon scaffold
f. heating the porous carbon scaffold particles to a temperature of 350° C. to 550° C. in the presence of silane gas; and
g. wherein the silicon-carbon composite comprises:
   i. a carbon scaffold comprising I_{D}/I_{G}<0.9 and a pore volume, wherein the pore volume comprises greater than 50% microporosity; and
   ii. a silicon content of 30% to 60% by weight;
   iii. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis;
   iv. a surface area less than 30 m2/g; and
   v. a φ of greater than or equal to 0.1, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

Embodiment 9. The process for preparing silicon-carbon composite particles of any of Embodiments 1 through Embodiment 8 wherein the pore volume comprises greater than 80% microporosity.

Embodiment 10. The process for preparing silicon-carbon composite particles of any of Embodiments 1 through Embodiment 9 wherein the pore volume comprises greater than 90% microporosity.

Embodiment 11. The process for preparing silicon-carbon composite particles of any of Embodiments 1 through Embodiment 10 wherein the pore volume comprises greater than 95% microporosity.

Embodiment 12. The process for preparing silicon-carbon composite particles of any of Embodiments 1 through Embodiment 11 wherein the porous carbon scaffold particles are heated to a temperature of 400° C. to 525° C. in the presence of silane gas

Embodiment 13. The process for preparing silicon-carbon composite particles of any of Embodiments 1 through Embodiment 12 wherein the silicon-carbon composite comprises a silicon content of 40-60%.

Embodiment 14. The process for preparing silicon-carbon composite particles of any of Embodiments 1 through Embodiment 13 wherein the silicon-carbon composite comprises a Z less than 5.

Embodiment 15. The process for preparing silicon-carbon composite particles of any of Embodiments 1 through Embodiment 14 wherein the silicon-carbon composite comprises a surface area less than 10 m2/g.

Embodiment 16. The process for preparing silicon-carbon composite particles of any of Embodiments 1 through Embodiment 15 wherein the silicon-carbon composite comprises a φ of greater than or equal to 0.2, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

Embodiment 17. The process for preparing silicon-carbon composite particles of any of Embodiments 1 through Embodiment 16 wherein the silicon-carbon composite comprises a φ of greater than or equal to 0.3, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

Embodiment 18. The process for preparing silicon-carbon composite particles of any of the embodiments from Embodiment 1 through Embodiment 17 wherein the silicon-carbon composite comprises a Dv50 between 5 nm and 20 microns.

Embodiment 19. The process for preparing silicon-carbon composite particles of any of the embodiments from Embodiment 1 through Embodiment 18 wherein the silicon-carbon composite comprises a capacity of greater than 900 mA/g.

Embodiment 20. The process for preparing silicon-carbon composite particles of any of the embodiments from Embodiment 1 through Embodiment 319 wherein the silicon-carbon composite comprises a capacity of greater than 1300 mA/g.

Embodiment 21. The process for preparing silicon-carbon composite particles of any of the embodiments from Embodiment 1 through Embodiment 20 wherein the silicon-carbon composite comprises a capacity of greater than 1600 mA/g.

Embodiment 22. The process for preparing silicon-carbon composite particles of any of the embodiments from Embodiment 1 through Embodiment 21 wherein the porous carbon scaffold comprises a I_{D}/I_{G}<0.8.

Embodiment 23. The process for preparing silicon-carbon composite particles of any of the embodiments from Embodiment 1 through Embodiment 22 wherein the porous carbon scaffold comprises a I_{D}/I_{G}<0.7.

Embodiment 24. The process for preparing silicon-carbon composite particles of any of the embodiments from Embodiment 1 through Embodiment 23 wherein the porous carbon scaffold comprises a I_{D}/I_{G}<0.6.

Embodiment 25. The process for preparing silicon-carbon composite particles of any of the embodiments from Embodiment 1 through Embodiment 24 wherein the porous carbon scaffold comprises a I_{D}/I_{G}<0.5.

Embodiment 26. The process for preparing silicon-carbon composite particles of any of the embodiments from Embodiment 1 through Embodiment 25 wherein the porous carbon scaffold comprises a I_{D}/I_{G}<0.4.

Embodiment 27. The process for preparing silicon-carbon composite particles of any of the embodiments from Embodiment 1 through Embodiment 26 wherein the porous carbon scaffold comprises a I_{D}/I_{G}<0.3.

Embodiment 28. The process for preparing silicon-carbon composite particles of any of the embodiments from Embodiment 1 through Embodiment 27 wherein the porous carbon scaffold comprises a I_{D}/I_{G}<0.2.

Embodiment 29. The process for preparing silicon-carbon composite particles of any of the embodiments from Embodiment 1 through Embodiment 28 wherein the porous carbon scaffold comprises a I_{D}/I_{G}<0.1.

Embodiment 30. The process for preparing silicon-carbon composite particles of any of the embodiments from Embodiment 1 through Embodiment 29 wherein the porous carbon scaffold comprises a I_{D}/I_{G}<0.01.

Embodiment 31. The process for preparing silicon-carbon composite particles of any of the embodiments from Embodiment 1 through Embodiment 30 wherein the porous carbon scaffold comprises a I_{D}/I_{G}<0.001.

Embodiment 32. The process for preparing silicon-carbon composite particles of any of the embodiments from Embodiment 1 through Embodiment 31 wherein the graphitization is accomplished by heating the carbon to a temperature of 1100° C. to 3000° C. in the presence of an inert gas.

Embodiment 33. The process for preparing silicon-carbon composite particles of any of the embodiments from Embodiment 1 through Embodiment 32 wherein the graphitization is accomplished by heating the carbon by microwave irradiation.

Embodiment 34. The process for preparing silicon-carbon composite particles of any of the embodiments from Embodiment 1 through Embodiment 33 wherein the porous carbon scaffold comprises Al, Cr, Mn, Fe, Co, Ni, Ca, Ti, V, Mo, or W, or combinations thereof.

Embodiment 35. The process for preparing silicon-carbon composite particles of any of the embodiments from Embodiment 1 through Embodiment 34 wherein the porous carbon scaffold comprises conductive carbon additive particles.

Embodiment 36. The process for preparing silicon-carbon composite particles of Embodiment 35 wherein the conductive carbon additive particles comprise graphite particles, Super C45 particles, Super P particles, carbon black particles, nanoscale carbon particles such as carbon nanotubes or other carbon nanostructures, or combinations thereof.

Embodiment 37. The process for preparing silicon-carbon composite particles of any of the embodiments from Embodiment 1 through Embodiment 36 wherein the inert gas is nitrogen gas.

Embodiment 38. The process for preparing silicon-carbon composite particles of any of the embodiments from Embodiment 1 through Embodiment 36 wherein the activation gas is carbon dioxide, steam, or combination thereof.

Embodiment 39. A silicon-carbon composite comprising:
a. a carbon scaffold comprising a carbon scaffold comprising I_{D}/I_{G}<0.9 and a pore volume, wherein the pore volume comprises greater than 70% microporosity;
b. a silicon content of 30% to 60% by weight;
c. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis;
d. a surface area less than 30 m2/g; and
e. a φ of greater than or equal to 0.1, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

Embodiment 40. The silicon-carbon composite of Embodiment 39 wherein the porous carbon scaffold comprises 40% to 60% silicon by weight.

Embodiment 41. The silicon-carbon composite of any one of embodiments from Embodiment 39 to Embodiment 40 wherein the wherein the silicon-carbon composite comprises a Z less than 5.

Embodiment 42. The silicon-carbon composite of any one of embodiments from Embodiment 39 to Embodiment 41 wherein the wherein the silicon-carbon composite comprises a surface area less than 10 m2/g.

Embodiment 43. The silicon-carbon composite of any one of embodiments from Embodiment 39 to Embodiment 42 wherein the wherein the silicon-carbon composite comprises a φ of greater than or equal to 0.2.

Embodiment 44. The silicon-carbon composite of any one of embodiments from Embodiment 39 to Embodiment 43 wherein the wherein the silicon-carbon composite comprises a φ of greater than or equal to 0.3.

Embodiment 45. The silicon-carbon composite of any one of embodiments from Embodiment 39 to Embodiment 44 wherein the wherein the silicon-carbon composite comprises a Dv50 between 5 nm and 20 microns.

Embodiment 46. The silicon-carbon composite of any one of embodiments from Embodiment 39 to Embodiment 45 wherein the wherein the silicon-carbon composite comprises a capacity of greater than 900 mA/g.

Embodiment 47. The silicon-carbon composite of any one of embodiments from Embodiment 39 to Embodiment 46 wherein the wherein the silicon-carbon composite comprises a capacity of greater than 1300 mA/g.

Embodiment 48. The silicon-carbon composite of any one of embodiments from Embodiment 39 to Embodiment 47 wherein the wherein the silicon-carbon composite comprises a capacity of greater than 1600 mA/g.

Embodiment 49. The silicon-carbon composite of any one of embodiments from Embodiment 39 to Embodiment 48 wherein the wherein the porous carbon scaffold comprises a I_{D}/I_{G}<0.8.

Embodiment 50. The silicon-carbon composite of any one of embodiments from Embodiment 39 to Embodiment 49 wherein the wherein the porous carbon scaffold comprises a I_{D}/I_{G}<0.7.

Embodiment 51. The silicon-carbon composite of any one of embodiments from Embodiment 39 to Embodiment 50 wherein the wherein the porous carbon scaffold comprises a I_{D}/I_{G}<0.6.

Embodiment 52. The silicon-carbon composite of any one of embodiments from Embodiment 39 to Embodiment 51 wherein the wherein the porous carbon scaffold comprises a I_{D}/I_{G}<0.5.

Embodiment 53. The silicon-carbon composite of any one of embodiments from Embodiment 39 to Embodiment 52 wherein the wherein the porous carbon scaffold comprises a I_{D}/I_{G}<0.4.

Embodiment 54. The silicon-carbon composite of any one of embodiments from Embodiment 39 to Embodiment 53 wherein the wherein the porous carbon scaffold comprises a I_{D}/I_{G}<0.3.

Embodiment 55. The silicon-carbon composite of any one of embodiments from Embodiment 39 to Embodiment 54 wherein the wherein the porous carbon scaffold comprises a I_{D}/I_{G}<0.2.

Embodiment 56. The silicon-carbon composite of any one of embodiments from Embodiment 39 to Embodiment 55 wherein the wherein the porous carbon scaffold comprises a I_{D}/I_{G}<0.1.

Embodiment 57. The silicon-carbon composite of any one of embodiments from Embodiment 39 to Embodiment 56 wherein the wherein the porous carbon scaffold comprises a I_{D}/I_{G}<0.01.

Embodiment 58. The silicon-carbon composite of any one of embodiments from Embodiment 39 to Embodiment 57 wherein the wherein the porous carbon scaffold comprises a I_{D}/I_{G}<0.001.

Embodiment 59. The silicon-carbon composite of any one of embodiments from Embodiment 39 to Embodiment 58 wherein the porous carbon scaffold comprises Al, Cr, Mn, Fe, Co, Ni, Ca, Ti, V, Mo, or W, or combinations thereof.

Embodiment 60. The silicon-carbon composite of any one of embodiments from Embodiment 39 to Embodiment 59 wherein the porous carbon scaffold comprises conductive carbon additive particles comprising graphite particles, Super C45 particles, Super P particles, carbon black particles, nanoscale carbon particles such as carbon nanotubes or other carbon nanostructures, or combinations thereof.

Embodiment 61. The silicon-carbon composite of any one of embodiments from Embodiment 39 to Embodiment 60 wherein the silicon-carbon composite comprises a Dv50 between 5 nm and 20 microns.

Embodiment 62. The silicon-carbon composite of any one of embodiments from Embodiment 39 to Embodiment 61 wherein the silicon-carbon composite comprises a ΔI_{D}/I_{G} of 0.1 to 0.7, wherein ΔI_{D}/I_{G}−([I_{D}/I_{G}]Dv,50>1−[I_{D}/I_{G}]Dv,50<1), wherein [I_{D}/I_{G}]Dv,50>1 is the I_{D}/I_{G} for the fraction of particles comprising Dv50>1 and [I_{D}/I_{G}]Dv,50<1 is the I_{D}/I_{G} for the fraction of particles comprising Dv50<1.

Embodiment 63. A silicon-carbon composite comprising a ΔI_{D}/I_{G} of 0.1 to 0.7, wherein ΔI_{D}/I_{G}=([I_{D}/I_{G}]Dv,50>1−[I_{D}/I_{G}]Dv,50<1), wherein [I_{D}/I_{G}]Dv,50>1 is the I_{D}/I_{G} for the fraction of particles comprising Dv50>1 and [I_{D}/I_{G}]Dv,50<1 is the I_{D}/I_{G} for the fraction of particles comprising Dv50<1.

Embodiment 64. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas
d. graphitizing the activated carbon material at a temperature of 1200 C to 3000 C in the presence on an inert gas;
e. comminuting the porous carbon scaffold
f. heating the porous carbon scaffold particles to a temperature of 350° C. to 550° C. in the presence of silane gas; and
g. wherein the silicon-carbon composite comprises:
   i. a carbon scaffold comprising I_{D}/I_{G}<0.9 and a pore volume, wherein the pore volume comprises greater than 70% microporosity; and
   ii. a silicon content of 30% to 60% by weight;
   iii. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis;
   iv. a surface area less than 30 m2/g;
   v. a φ of greater than or equal to 0.1, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V;
   vi. a first cycle efficiency greater than or equal to 75%
   vii. an average Coulombic efficiency greater than or equal to 0.998; and
   viii. a capacity greater than or equal to 1000 mAh/g

Embodiment 65. A process for preparing silicon-carbon composite particles comprising:
a. providing a mixture of solid carbon precursor materials;
b. pyrolzying the mixture at a temperature of 650° C. to 1100° C. in the presence of an inert gas;
c. activating the pyrolyzed carbon material at a temperature of 650° C. to 1100° C. in the presence of an activation gas
d. graphitizing the activated carbon material at a temperature of 1200 C to 3000 C in the presence on an inert gas;
e. comminuting the porous carbon scaffold
f. heating the porous carbon scaffold particles to a temperature of 350° C. to 550° C. in the presence of silane gas; and
g. wherein the silicon-carbon composite comprises:
   ix. a carbon scaffold comprising I_{D}/I_{G}<0.9 and a pore volume, wherein the pore volume comprises greater than 70% microporosity; and
   x. a silicon content of 30% to 60% by weight;
   xi. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis;
   xii. a surface area less than 30 m2/g;
   xiii. a φ of greater than or equal to 0.2, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V;
   xiv. a first cycle efficiency greater than or equal to 90%
   xv. an average Coulombic efficiency greater than or equal to 0.999; and
   xvi. a capacity greater than or equal to 1400 mAh/g

Embodiment 66. A process for preparing graphitized activated carbon particles comprising:
a. providing a mixture of solid carbon precursor materials;
b. pyrolzying the mixture at a temperature of 650° C. to 1100° C. in the presence of an inert gas;
c. comminuting the pyrolyzed porous carbon scaffold
d. graphitizing the activated carbon material at a temperature of 1200 C to 3000 C in the presence on an inert gas.
e. activating the pyrolyzed carbon material at a temperature of 650° C. to 1100° C. in the presence of an activation gas

Embodiment 67. A material comprising graphitized activated carbon particles comprising:
a. surface area greater than or equal to 40 m2/g
b. pore volume greater than or equal to 0.05 cm3/g
c. Lₐ greater than or equal to 5 A
d. I_{D}/I_{G} less than or equal to 0.8

Embodiment 68. A material comprising graphitized activated carbon particles comprising:
a. surface area greater than or equal to 400 m2/g
b. pore volume greater than or equal to 0.5 cm3/g
c. Lₐ greater than or equal to 5 A
d. I_{D}/I_{G} less than or equal to 0.8

Embodiment 69. A material comprising graphitized activated carbon particles comprising:
a. surface area greater than or equal to 1000 m2/g
b. pore volume greater than or equal to 0.6 cm3/g
c. Lₐ greater than or equal to 5 A
d. I_{D}/I_{G} less than or equal to 0.8

From the foregoing it will be appreciated that, although specific embodiments of the invention have been described herein for purposes of illustration, various modifications may be made without deviating from the spirit and scope of the invention. Accordingly, the invention is not limited except as by the appended claims.

U.S. Provisional Patent Application No. 63/083,614, filed Sep. 25, 2020, to which the present application claims priority, is hereby incorporated herein by reference in its entirety.

1. A process for preparing silicon-carbon composite particles comprising:
a. providing a mixture of solid carbon precursor materials;
b. pyrolzying the mixture at a temperature of 650° C. to 1100° C. in the presence of nitrogen gas to obtain a pyrolyzed carbon material;
c. activating the pyrolyzed carbon material at a temperature of 650° C. to 1100° C. in the presence of carbon dioxide gas, steam, or combinations thereof, to obtain an activated carbon material;
d. comminuting the activated carbon material to obtain porous carbon scaffold particles;
e. heating the porous carbon scaffold particles to a temperature of 1100° C. to 3000° C. in the presence of nitrogen;
f. heating the porous carbon scaffold particles to a temperature of 400° C. to 525° C. in the presence of silane gas; and
g. wherein the silicon-carbon composite comprises:
i. a carbon scaffold comprising a I_{D}/I_{G} less than 0.8 and a pore volume, wherein the pore volume comprises greater than 70% microporosity.

2. The process of claim 1 wherein the solid carbon precursor materials comprise bisphenol A and hexamethylenetetramine.

3. The process of claim 1 wherein the carbon scaffold pore volume comprises greater than 80% microporosity.

4. The process of claim 1 wherein the carbon scaffold pore volume comprises greater than 90% microporosity.

5. The process of claim 1 wherein the carbon scaffold pore volume comprises greater than 95% microporosity.

6. The process of claim 1 wherein the I_{D}/I_{G} is less than 0.7

7. The process of claim 1 wherein the I_{D}/I_{G} is less than 0.6.

8. A process for preparing silicon-carbon composite particles comprising:
a. providing a mixture of solid carbon precursor materials;
b. pyrolzying the mixture at a temperature of 650° C. to 1100° C. in the presence of nitrogen gas to obtain a pyrolyzed carbon material;
c. activating the pyrolyzed carbon material at a temperature of 650° C. to 1100° C. in the presence of carbon dioxide gas, steam, or combinations thereof, to obtain an activated carbon material;
d. comminuting the activated carbon material to obtain porous carbon scaffold particles;
e. heating the porous carbon scaffold particles to a temperature of 1100° C. to 3000° C. in the presence of nitrogen;
f. heating the porous carbon scaffold particles to a temperature of 400° C. to 525° C. in the presence of silane gas; and
g. wherein the silicon-carbon composite comprises:
i. a carbon scaffold comprising a I_{D}/I_{G} less than 0.8 and a pore volume, wherein the pore volume comprises greater than 70% microporosity.
ii. a silicon content of 40% to 60% by weight;
iii. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis;
iv. a surface area less than 30 m2/g; and
v. a φ of greater than or equal to 0.1, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

9. The process of claim 8 wherein the solid carbon precursor materials comprise bisphenol A and hexamethylenetetramine.

10. The process of claim 8 wherein the carbon scaffold pore volume comprises greater than 80% microporosity.

11. The process of claim 8 wherein the I_{D}/I_{G} is less than 0.7

12. The process of claim 8 wherein the Z is less than 5.

13. The process of claim 8 wherein the silicon-carbon composite surface area less is than 10 m2/g.

14. The process of claim 8 wherein the φ is greater than or equal to 0.2

15. A silicon-carbon composite comprising a ΔI_{D}/I_{G} of 0.1 to 0.7, wherein ΔI_{D}/I_{G}=([I_{D}/I_{G}]Dv,50>1˜[I_{D}/I_{G}]Dv,50<1), wherein [I_{D}/I_{G}]Dv,50>1 is the I_{D}/I_{G} for the fraction of particles comprising Dv50>1 and [I_{D}/I_{G}]Dv,50<1 is the I_{D}/I_{G} for the fraction of particles comprising Dv50<1.

16. A silicon-carbon composite comprising:
a. a carbon scaffold comprising a carbon scaffold comprising a I_{D}/I_{G}<0.8 and a pore volume, wherein the pore volume comprises greater than 70% microporosity;
b. a silicon content of 40% to 60% by weight;
c. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis;
d. a surface area less than 30 m2/g; and
e. a φ of greater than or equal to 0.1, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V.

17. The silicon-carbon composite of claim 16 wherein the carbon scaffold pore volume comprises greater than 80% microporosity.

18. The silicon-carbon composite of claim 16 wherein the I_{D}/I_{G} is less than 0.7

19. The silicon-carbon composite of claim 16 wherein the Z is less than 5.

20. The silicon-carbon composite of claim 16 wherein the silicon-carbon composite surface area is less than 10 m2/g.

21. The silicon-carbon composite of claim 16 wherein the φ is greater than or equal to 0.2.

22. The silicon-carbon composite of claim 16 further comprising Al, Cr, Mn, Fe, Co, Ni, Ca, Ti, V, Mo, or W, or combinations thereof

23. The silicon-carbon composite of claim 16 further comprising Ni.

24. The silicon-carbon composite of claim 16 further comprising conductive carbon additive particles.

25. The silicon-carbon composite of claim 16 further comprising graphite particles, Super C45 particles, Super P particles, carbon black particles, nanoscale carbon particles such as carbon nanotubes or other carbon nanostructures, or combinations thereof.

26. The silicon-carbon composite of claim 16 further comprising conductive carbon additive particles.

27. The silicon-carbon composite of claim 16 comprising a Dv50 between 5 nm and microns.

28. A process for preparing silicon-carbon composite particles comprising:
h. providing a mixture of solid carbon precursor materials;
i. pyrolzying the mixture at a temperature of 650° C. to 1100° C. in the presence of an inert gas;
j. activating the pyrolyzed carbon material at a temperature of 650° C. to 1100° C. in the presence of an activation gas
k. graphitizing the activated carbon material at a temperature of 1200 C to 3000 C in the presence on an inert gas;
l. comminuting the porous carbon scaffold
m. heating the porous carbon scaffold particles to a temperature of 350° C. to 550° C. in the presence of silane gas; and
n. wherein the silicon-carbon composite comprises:
xvii. a carbon scaffold comprising I_{D}/I_{G}≤0.9 and a pore volume, wherein the pore volume comprises greater than 70% microporosity; and
xviii. a silicon content of 30% to 60% by weight;
xix. a Z of less than 10, wherein Z=1.875×[(M1100−M)/M1100]×100%, wherein M1100 is a mass of the silicon-carbon composite at 1100° C. and M is the minimum mass of the silicon-carbon composite between 800° C. and 1100° C. when the silicon-carbon composite is heated under air from about 25° C. to about 1100° C., as determined by thermogravimetric analysis;
xx. a surface area less than 30 m2/g;
xxi. a φ of greater than or equal to 0.2, wherein φ=(Max peak height dQ/dV in Regime I)/(Max peak height dQ/dV in Regime III), wherein dQ/dV is measured in a half-cell coin cell, and Regime I is 0.8V−0.4V and Regime III is 0.15V−0V;
xxii. a first cycle efficiency greater than or equal to 90%
xxiii. an average Coulombic efficiency greater than or equal to 0.999; and
xxiv. a capacity greater than or equal to 1400 mAh/g

29. A process for preparing graphitized activated carbon particles comprising:
f. providing a mixture of solid carbon precursor materials;
g. pyrolzying the mixture at a temperature of 650° C. to 1100° C. in the presence of an inert gas;
h. comminuting the pyrolyzed porous carbon scaffold
i. graphitizing the activated carbon material at a temperature of 1200 C to 3000 C in the presence on an inert gas.
j. activating the pyrolyzed carbon material at a temperature of 650° C. to 1100° C. in the presence of an activation gas

30. A material comprising graphitized activated carbon particles comprising:
e. surface area greater than or equal to 40 m2/g
f. pore volume greater than or equal to 0.05 cm3/g
g. Lₐ greater than or equal to 5 A
h. I_{D}/I_{G} less than or equal to 0.8

31. A material comprising graphitized activated carbon particles comprising:
e. surface area greater than or equal to 400 m2/g
f. pore volume greater than or equal to 0.5 cm3/g
g. Lₐ greater than or equal to 5 A
h. I_{D}/I_{G} less than or equal to 0.8

32. A material comprising graphitized activated carbon particles comprising:
e. surface area greater than or equal to 1000 m2/g
f. pore volume greater than or equal to 0.6 cm3/g
g. Lₐ greater than or equal to 5 A
h. I_{D}/I_{G} less than or equal to 0.8
